(19) United States
(12) Patent Application Publication
(10) Pub. No.: US 2024/0335340 A1
(43) Pub. Date: Oct. 10, 2024

(54) MEASURING AND ADJUSTING PRESSURE OF SUPPORT CUSHIONS

(71) Applicant: Kalogon, Inc., Melbourne, FL (US)

(72) Inventors: Timothy Balz, Melbourne, FL (US); Christian Balcom, Cocoa, FL (US); Connor Crenshaw, Orlando, FL (US); Jake Milanowski, Melbourne, FL (US); Evan Rosenberg, Rockledge, FL (US)

(21) Appl. No.: 18/632,099

(22) Filed: Apr. 10, 2024

Related U.S. Application Data
(60) Provisional application No. 63/458,436, filed on Apr. 10, 2023.

(51) Int. Cl. A61G 5/10; A47C 7/14

(52) U.S. Cl. CPC A61G 5/1056; A47C 7/142; A61G 5/1045; A61G 2203/30

(57) ABSTRACT

A method for controlling a cushion is disclosed. The method involves receiving digital data that corresponds to signals from at least one pressure transducer that is pneumatically coupled to a bladder of a cushion, determining that the digital data includes an indication of at least one of a heart beat and breathing, determining that a person is sitting on the cushion in response to determining that the digital data includes an indication of at least one of a heart beat and breathing, and applying a control signal within the controller in response to determining that a person is sitting on the cushion.

### RELATED APPLICATIONS

This Application is entitled to the benefit of provisional U.S. Patent Application Ser. No. 63/458,436, filed Apr. 10, 2023, which is incorporated by reference herein.

### BACKGROUND

This background is provided as a convenience to the reader and does not admit to any prior art or restrict the scope of the disclosure or the invention. This background is intended as an introduction to the general nature of technology to which the disclosure or the invention can be applied.

Patients and other users with restricted mobility, or who otherwise have difficulty obtaining comfortable seating, might sometimes be subject to adverse medical conditions, such as pressure sores or decubitus ulcers. These conditions, left undetected or untreated, can involve serious adverse consequences, such as loss of muscle mass, serious infection, and even death. One solution for these patients is to provide a cushion on which to sit or lie down. The cushion can provide support for the patient's anatomy, such as to prevent pressure between a supporting surface, such as a wheelchair or other chair, and any bony parts or other hard parts of the patient's anatomy. This can help prevent undue pressure upon the musculature or other portions of the patient's body.

However, one source of excessive pressure on the user's body can occur when the user “bottoms out”, that is, when one or more bony structures (such as the user's ischial tuberosities, the “sitting bones” or “sitz bones”), or other hard parts of the user's body, exerts pressure on the surface on which the user is sitting or lying down. When the user is sitting on an inflated cushion, this can occur when the cushion is under-inflated or otherwise inadequately supporting the user.

One method of testing for bottoming-out includes (1) over-inflating the cushion and having the user sit on it; (2) venting the cushion and having a clinician, or other medical personnel, determine if the user's lowest bony prominences are contacting the surface beneath the cushion, such as a wheelchair or other supporting surface; (3) in a “two-finger method”, the clinician wiggles two fingers underneath the user's lowest bony prominences to determine if those prominences exert excessive pressure on the supporting surface; (4) if the clinician feels excessive pressure, that suggests that the user has bottomed-out; (5) if not, the clinician determines if the cushion is over-inflated.

While maintaining the cushion over-inflated can become a problem, bottoming-out is a concern more directly related to the user's health. Accordingly, it is useful to check for bottoming-out before evaluating the inflation state of the cushion. However, the two-finger method can be subjective and can produce pressure values which are incorrect. Accordingly, it would be advantageous to provide a setup procedure that is relatively automatic and not subjective.

Moreover, requiring the personal attention of a clinician, or other medical personnel, can have the negative effect that checking the user for possible bottoming-out might occur less frequently than desirable. For example, a leaky cushion might cause the user to bottom-out after excessive leakage occurs. Accordingly, it would be advantageous to determine possible bottoming-out automatically and without intervention by any skilled professionals.

Another concern with respect to patients and other users is that desired pressure exerted by the cushion might differ in response to the user's weight (or changes in the user's weight), in response to objects being carried by the user, in response to changes in ambient air pressure (such as might occur during airline flight), in response to leaks in the cushion or its air bladders, or otherwise for which the cushion (or a controller thereof) might find it advantageous to adjust a pressure. Another concern with respect to patients and other users is that the user might have difficulty performing an “offload” (exiting the cushion), possibly due to the user's restricted mobility or seating fatigue.

Accordingly, it would be advantageous to provide a device, and method of operating that device, which can determine whether the user has bottomed-out or is in danger thereof. For example, the device might be able to determine whether the user is currently seated on the cushion, whether the user is exhibiting discomfort, whether the cushion is subject to leaks or changes in ambient pressure, or otherwise might benefit from adjustment to its inflation/deflation.

The techniques described herein can also be useful for patients and other users, whether they have restricted mobility or are otherwise fully mobile. When users remain seated, or otherwise immobile, for an extended duration (such as being confined to a hospital bed or to a wheelchair), those users might be subject to “seating fatigue”. This can lead to cramped muscles, pain, sores, or other discomfort, even for completely healthy persons. For example, persons who participate in extended automobile (including both passengers and operators) or airline travel (including both passengers and pilots) might find it necessary to leave their seats and stretch periodically. But this can be difficult in a moving vehicle or if the user is otherwise temporarily constrained.

### SUMMARY OF THE DISCLOSURE

A method for controlling a cushion is disclosed. The method involves receiving digital data that corresponds to signals from at least one pressure transducer that is pneumatically coupled to a bladder of a cushion, determining that the digital data includes an indication of at least one of a heart beat and breathing, determining that a person is sitting on the cushion in response to determining that the digital data includes an indication of at least one of a heart beat and breathing, and applying a control signal within the controller in response to determining that a person is sitting on the cushion.

In an example, determining that the digital data includes an indication of at least one of a heart beat and breathing involves filtering the digital data to pass digital data at a frequency of a heartbeat of a human.

In an example, the frequency of a heartbeat of a human is in the range of about 60-80 beats per minute.

In an example, determining that the digital data includes an indication of at least one of a heart beat and breathing involves filtering the digital data to pass digital data at a frequency of breathing of a human.

In an example, the frequency of breathing of a human is in the range of about 10-20 breaths per minute.

In an example, determining that the digital data includes an indication of at least one of a heart beat and breathing involves performing a frequency transform of the digital data, and determining that the digital data includes an indication of at least one of a heart beat and breathing from the frequency transform.

In an example, determining that the digital data includes an indication of at least one of a heart beat and breathing involves performing a frequency transform of the digital data, and determining that the digital data includes an indication of at least one of a heart beat and breathing from noise in the frequency transform.

In an example, determining that the digital data includes an indication of at least one of a heart beat and breathing involves determining moving averages of the digital data.

In an example, determining that the digital data includes an indication of at least one of a heart beat and breathing involves determining moving averages of the digital data, and applying the moving averages to a neural network that is configured to output a confidence value with respect to whether a heartbeat or breathing is present in the digital data.

In an example, determining that the digital data includes an indication of at least one of a heart beat and breathing involves determining moving averages of the digital data, and filtering the moving averages to remove frequencies that are too high to be associated with a human heartbeat.

In an example, determining that the digital data includes an indication of at least one of a heart beat and breathing involves determining moving averages of the digital data, and filtering the moving averages to remove frequencies that are above about 80 beats per minute.

A controller for a cushion is also disclosed. The controller includes a processor configured to receive digital data that corresponds to signals from a pressure transducer that is pneumatically coupled to a bladder of a cushion, determine that the digital data includes an indication of at least one of a heart beat and breathing, determine that a person is sitting on the cushion in response to determining that the digital data includes an indication of at least one of a heart beat and breathing, and apply a control signal within the controller in response to determining that a person is sitting on the cushion.

In an example, determining that the digital data includes an indication of at least one of a heart beat and breathing involves filtering the digital data to pass digital data at a frequency of a heartbeat of a human.

In an example, the frequency of a heartbeat of a human is in the range of about 60-80 beats per minute.

In an example, determining that the digital data includes an indication of at least one of a heart beat and breathing involves filtering the digital data to pass digital data at a frequency of breathing of a human.

In an example, the frequency of breathing of a human is in the range of about 10-20 breaths per minute.

In an example, determining that the digital data includes an indication of at least one of a heart beat and breathing involves performing a frequency transform of the digital data, and determining that the digital data includes an indication of at least one of a heart beat and breathing from the frequency transform.

In an example, determining that the digital data includes an indication of at least one of a heart beat and breathing involves performing a frequency transform of the digital data, and determining that the digital data includes an indication of at least one of a heart beat and breathing from noise in the frequency transform.

In an example, determining that the digital data includes an indication of at least one of a heart beat and breathing involves determining moving averages of the digital data.

In an example, determining that the digital data includes an indication of at least one of a heart beat and breathing involves determining moving averages of the digital data, and applying the moving averages to a neural network that is configured to output a confidence value with respect to whether a heartbeat or breathing is present in the digital data.

In an example, determining that the digital data includes an indication of at least one of a heart beat and breathing involves determining moving averages of the digital data, and filtering the moving averages to remove frequencies that are too high to be associated with a human heartbeat.

In an example, determining that the digital data includes an indication of at least one of a heart beat and breathing involves determining moving averages of the digital data, and filtering the moving averages to remove frequencies that are above about 80 beats per minute.

In an example, the controller further includes a port configured to hold a hose that channels air between the controller and the bladder of the cushion, a pump pneumatically connected to the port, and the pressure transducer pneumatically connected to the port.

In an example, the controller is external to the cushion.

Another example of a controller for a cushion is disclosed. The controller includes an inlet and outlet port, a pump pneumatically coupled to the inlet and outlet port, a vent pneumatically coupled to the inlet and outlet port, a pressure transducer pneumatically coupled to the inlet and outlet port, a battery, a user interface, and a processor configured to receive digital data that corresponds to signals from the pressure transducer when the pressure transducer is pneumatically coupled, via the inlet and outlet port, to a bladder of a cushion, determine that the digital data includes an indication of at least one of a heart beat and breathing, and determine that a person is sitting on the cushion in response to determining that the digital data includes an indication of at least one of a heart beat and breathing.

Other aspects and advantages of embodiments of the present invention will become apparent from the following detailed description taken in conjunction with the accompanying drawings.

### BRIEF DESCRIPTION OF THE FIGURES

FIG. 1 shows a conceptual drawing of an example system including a support cushion and control device.

FIG. 2A shows a pressure measurement graph comparing an X axis (e.g., a time value or a count of a number of pressure measurement data points) and a Y axis (e.g., a pressure value or a sensor value responsive to a pressure value).

FIG. 2B shows a frequency transform of the pressure graph comparing an X axis (e.g., a time value or a count of a number of pressure measurement data points) and a Y axis (e.g., a relative energy at a frequency of the pressure value or the sensor value responsive to a pressure value).

FIG. 2C shows a pressure measurement graph comparing an X axis (e.g., a time value or a count of a number of pressure measurement data points) and a Y axis (e.g., a pressure value or a sensor value responsive to a pressure value).

FIG. 2D shows a frequency transform of the pressure graph comparing an X axis (e.g., a time value or a count of a number of pressure measurement data points) and a Y axis (e.g., a relative energy at a frequency of the pressure value or the sensor value responsive to a pressure value).

FIG. 3A illustrates an example of unfiltered pressure measurement data comparing an X axis (e.g., a time value or a count of a number of pressure measurement data points) and a Y axis (e.g., an unfiltered pressure value or a sensor value responsive to a pressure value).

FIG. 3B illustrates an example of unfiltered pressure measurement data comparing an X axis (e.g., a time value or a count of a number of pressure measurement data points) and a Y axis (e.g., an unfiltered pressure value or a sensor value responsive to a pressure value).

FIG. 3C illustrates filtered pressure data comparing an X axis (e.g., a time value or a count of a number of pressure measurement data points) and a Y axis (e.g., normalized and filtered pressure values or a sensor values).

FIG. 4 shows a conceptual drawing of an example heartbeat-detection system with respect to a support cushion.

FIG. 5 shows a conceptual drawing of an example set of measurements of pressure to detect bottoming-out with respect to a support cushion.

FIG. 6A shows a conceptual drawing of an example process associated with detecting a cushion leak.

FIG. 6B shows an example graph of input volume of air vs. expected pressure gain.

FIG. 7 is a functional block diagram of a controller for a cushion.

FIG. 8 is a process flow diagram of a method for operating a control device for a cushion.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

### Control Device

A system can include a pressurized cushion with multiple cells and a control device disposed to adjust the pressure in one or more of those cells. Each of the cells can have its pressure separately measured and/or adjusted to support a user, such as when the user is seated on the cushion, the cushion being disposed on top of a support surface such as a wheelchair seat. The control device can be disposed to determine whether the user is actually present and sitting on the cushion, including determining whether the user is attempting to move off the cushion (an “offload”, as further defined herein) or onto the cushion (an “onload”, as further defined herein).

When the user is disposed on the cushion, the control device can maintain a set of pressure values associated with each of the cells to provide the user with sufficient support to maintain the user in a safe range above bottoming-out, without over-inflating the cushion. The control device can also allow the user to select from a set of selected configurations to provide for comfort in response to varying user size, weight, or other factors. Having determined a pressure (or range) at which to maintain the cushion, the control device can be coupled to a pressure sensor and can automatically control a pump/valve, without needing significant user control, to maintain and/or adjust pressure in the cushion. The pressure in the cushion can be selected by the user, caregivers, medical personnel, or otherwise as described herein.

The control device can also be either (1) already coupled to a cushion integrated with the control device, or (2) capable of being coupled to an independent cushion as a separate control device. In the latter case, the control device can be disposed to be used with (e.g., attached/removed) multiple cushions, in settings where multiple cushions are managed, such as hospitals, nursing homes, rehabilitation facilities, or otherwise as described herein. The control device can identify each such cushion, such as by its serial number or by the cushion's association with a selected user, to allow the control device to maintain each selected cushion at a pressure associated with its selected user, and to allow each such user to adjust the pressure of their particular cushion to suit their own comfort.

The control device can include a programmable logic controller (PLC), a microcontroller, a processor, another computing device, or otherwise as described herein. The control device can include a machine learning device or a neural network disposed to detect the user's state, such as whether there is any user actually present on the cushion, whether the user has an elevated heart rate or is otherwise subject to a selected medical condition, whether the user is fidgeting or is otherwise uncomfortable, whether the user is attempting to exit the cushion (sometimes referred to herein as “offloading” or “an offload”) or is otherwise moving, or otherwise as described herein.

The control device can include one or more pressure sensors, such as one pressure sensor for each of the multiple cells in the cushion. The control device can sense the amount of pressure in the each of the multiple cells in the cushion in response to pressure on each cell, such as (1) to determine an amount of weight being applied to the cell by the user; (2) to determine a change in pressure distribution on the cells, e.g., in response to movement or fidgeting by the user; (3) to determine when the user moves to lift themselves up from, or lower themselves onto, the cushion; (4) to determine when an air pressure of an ambient environment changes, such as in response to airline flight; (5) to determine whether the user is present on the cushion, such as in response to changes in pressure from the user's heartbeat, breathing, or otherwise; (6) to determine whether the cushion is no longer in a relatively safe range above “bottoming out”, thus, when the user is sitting or lying directly on a hard support; (7) to determine whether the pressure by the cell changes for another reason, such as leakage from a cell bladder; or otherwise as described herein.

The control device can adjust the pressure in response to the pressure sensor, such as (1) to adjust for changes in an amount of weight being applied by the user; (2) to adjust for movement or fidgeting by the user; (3) to adjust for an amount of air pressure being applied by an ambient environment; (4) to adjust an amount of air pressure being applied by individual bladders/cells to the user to assist the user with moving, such as to enter/exit a position on top of the cushion; (5) to adjust an amount of air pressure being applied by individual bladders/cells to the user to prevent the user from slipping off the cushion or otherwise leaning or sliding in a relatively unsafe manner; (6) to adjust an amount of air pressure being applied to the user to maintain the user in a relatively safe range above “bottoming out”, as described herein; or otherwise as described herein. This background is provided as a convenience to the reader and does not admit to any prior art or restrict the scope of the disclosure or the invention. This background is intended as an introduction to the general nature of technology to which the disclosure or the invention can be applied.

### Presence Detection

The control device can detect whether the user is located on the cushion. The control device can measure pressure in the cushion and changes of that pressure over time. (1) The control device can determine when the user transfers on/off the cushion by the relatively large difference in pressure that can occur. (2) The control device can filter the time-varying pressure value to restrict that time-varying signal to only those frequencies near those associated with user heartbeat, breathing, vibration from operation of a wheelchair, or other user functions as described herein. A relatively high-resolution sensor can detect user heartbeat or breathing, or possibly some user fidgeting. (3) The control device can combine information from multiple sources, such as whether the user is likely located on the cushion, whether a user heartbeat is detected, or otherwise as described herein, to more reliably determine whether the user is present.

In combination with filtering for pressure changes at frequencies associated with a user heartbeat or breathing, the control device can couple multiple sensors to a machine learning system (such as a neural network) or a state machine (such as a finite state machine), which can determine a likelihood or a measure of confidence with respect to whether the user is located on the cushion. The machine learning system can be pre-trained, or the finite state machine can be designed, using data associated with a selected set of users, such as possibly users who are similar to the user whose presence is to be detected. Similarly, the machine learning system can be pre-trained, or the finite state machine can be designed, using data associated with use of the wheelchair, such as possibly starting/stopping, accelerating/decelerating, or vibration from movement over a surface.

The control device can use information with respect to the user's disposition, such as whether the user is situated on the cushion, whether the user is moving the wheelchair, to determine whether pressure on the cushion is due to the weight of the user, due to overinflation of the cushion, or due to a leak in one or more of the cushion's air cells. The control device can use this information to determine whether to further inflate the cushion, to reduce any danger of the user bottoming-out, to inflate the cushion to compensate for a leak in one or more of the cushion's air cells (and possibly generate an alert to the user, or to one or more caregivers or other persons), or to refrain from further inflating the cushion to reduce any danger of overinflation and consequent damage to one or more cushion cells.

### Leak Detection

The control device can determine whether the cushion is leaking air, such as in response to a downward trend in pressure, as described herein. In one embodiment, when the control device detects reduced pressure, it can re-inflate the cushion to a safer or otherwise more acceptable amount of pressure. If this is inadequate to maintain pressure, the control device can determine that the cushion has a leak, and can alert the user, caregivers, medical personnel, or otherwise as described herein. For example, the control device can send an alert to a smartphone or other mobile device associated with the user, or to a display associated with the wheelchair on which the user and the cushion are located, either of which can present a status report to the user indicating that a leak was detected. The control device can also log its determination of the leak and alert personnel to replace the cushion.

### Long-Term Pressure Control

The control device can determine whether to adjust a baseline pressure for the cushion, such as in response to whether the cushion is above/below the user's desired pressure, or in response to another desirable pressure to maintain. In response thereto, the control device can direct the cushion's pumps/vents to adjust the baseline pressure upward/downward and can maintain the cushion's baseline pressure near the desired pressure or other desirable pressure. This can include the control device comparing a measured pressure with the desired pressure, determining when the measured pressure differs from the desired pressure, and determining whether the difference is relatively long-term or is only a short-term phenomenon. When the difference is relatively long-term, the control device can direct the pumps/vents in response to an amount of the difference.

### Pressure Autoset

The control device can use a pressure control technique to maintain a selected support pressure between about 0.45 psi and about 0.60 psi, although other amounts would be workable, particularly for users who are of unusual size or weight and are within the scope and spirit of the invention. (The inventors have discovered that bottoming-out often occurs at pressures of about 0.35 psi or lower, although other amounts are possible, particularly for users who are of unusual size or weight, or for other reasons as described herein.) The control device can maintain pressure between approximately these or other selected minimum/maximum bounds, in response to the user's size or weight, input or other feedback from the user or one or more caregivers or other persons, or other information with respect to operation of the cushion and/or its support of at least portions of the user.

The control device can include an input disposed to cause the control device to direct the cushion to “autoset” to a selected amount of pressure, possibly in response to one or more of: (1) measurements associated with the user (such as size, weight, age, other medical conditions, or otherwise as described herein), (2) information in response to input associated with one or more caregivers or other persons, such as a clinician, nurse, physician, physical therapist, a nearby “good Samaritan”, or another skilled individual; (3) other experimentally determined minimum or maximum pressure control parameters; or (4) in response to one or more biomechanical models of the user. The control device can include a sensor disposed to detect a bottoming-out event with respect to the user and can adjust selected pressure to be exerted in support of the user in response to the bottoming-out event.

### Setup and Profiles

The cushion and its associated control device (the latter of which can be attached to or integrated with the cushion or can be temporarily coupled to the cushion) can be calibrated with respect to the user, such as by the user themselves or by one or more caregivers or other persons, and such as in response to a change in size or weight of the user, a resilience or size of the cushion, one or more medical conditions associated with the user, or other information entered using an input device. The input device can include a smartphone or other mobile device operating under control of an application (“app”); an external device disposed to exchange information with the control device or the cushion; one or more sensors coupled to the cushion or the user; or otherwise as described herein. For example, the user, or one or more caregivers or other persons, can adjust the cushion pressure to be set by the control device in response to user feedback with respect to a desired amount of cushion firmness, a selected use case for the cushion (such as sitting or riding in a wheelchair or vehicle, or such as using a selected cushion or type of wheelchair or vehicle), or one or more other factors. Using the information calibrating the control device and/or the cushion with respect to the user, the control device can control pumping/venting of one or more individual air elements of the cushion without any particular requirement for manual control by the user, one or more caregivers or other persons, or otherwise as described herein. For example, the control device can control the pumping/venting in response to one or more of: a selected formula, a selected look-up table, a model of a general user or of the particular user, or otherwise as described herein.

In a circumstance in which more than one user is associated with a particular cushion or control device, the cushion and its associated control device can be calibrated with respect to a selected user, the particular user being selected by a clinician, nurse, physician, physiotherapist, or another person, or by the user themselves. Similarly, a selected user can be calibrated for more than one such cushion or more than one such use case, the selection being made at a time when the cushion is set up for use or when the use case is initiated. In such cases, individualized history for each such cushion, use case, user, or combination or conjunction thereof, can be separately maintained by the control device, or by memory or a storage device coupled thereto, and selected at an appropriate time.

### Ambient Pressure

The control device can detect and respond to changes in the ambient pressure, such as due to atmospheric pressure changes from elevation (which might occur due to air travel or travel in elevated terrain) or weather (which might occur due to low-pressure or high-pressure formations). The control device can determine a pressure differential between the pressure in one or more cushion cells and an ambient pressure, sometimes called a “differential pressure” herein. The control device can adjust pressure within one or more cells of the cushion in response to differential pressure, and in response to changes in differential pressure. The control device can also alert the user (or one or more caregivers or other persons) in response to changes in differential pressure, such as to inform the user that any changes in cushion support are in response to changes in differential pressure.

The control device can determine a measure of internal pressure (such as a measure of pressure exerted by the air mass on an external surface of the cushion) and a measure of external pressure (such as a measure of pressure exerted by an ambient pressure from the atmosphere). Alternatively, the control device can determine the ambient pressure from the atmosphere in response to a differential pressure measurement between the internal pressure and the external pressure. The ambient pressure from the atmosphere can change, such as in response to either (1) a change in altitude of the cushion, such as might occur when the user brings the cushion on a commercial air flight or in a vehicle that climbs/descends altitude in response to terrain; or (2) a change in ambient weather, such as might occur when the user enters/exits a high-pressure weather pattern or a low-pressure weather pattern. In such cases, the control device can adjust an amount of air mass to pump into or vent out of the cushion, to maintain a relatively consistent amount of support for the user, or can alert the user (or one or more caregivers or other persons) of any desired change in the amount of air mass to maintain in the cushion to maintain a relatively consistent amount of support for the user, without any substantial requirement for the user or caregivers to manually adjust the air mass maintained in the cushion.

In one embodiment, the control device can maintain a selected range, such as including a minimum/maximum pressure for the cushion to exert in support of the user. The control device can maintain the selected range in response to the selected pressure to be exerted in support of the user, such as determined using the “autoset” procedure as described herein. The control device can sample an amount of differential pressure or an amount of ambient pressure, filtering a time-varying amount of pressure to avoid transient pressure spikes, and in response thereto, (1) identify a trend in pressure of the ambient environment, and (2) adjust the air mass in the cushion. In response to a selected threshold difference in ambient pressure, such as greater than about 0.05 psi, the control device can direct a pump/vent system coupled to the cushion to adjust the air mass in the cushion.

### Multicell Control

The cushion can include a set of more than one distinct and/or separate internal air element, such as a bladder disposed to be pumped/vented to adjust its support of the user. The control device can determine an individual amount of air mass, and associated pressure exerted in support of the user, for each such internal air element, to allow the control element to exert a select amount of pressure in support of each portion of the user. In such cases, the control device can be coupled to a distinct and/or separate sensor associated with each such air element and can be coupled to a distinct (or a multiplexed) pump/vent associated with each such air element. Thus, the user's buttocks can be supported with a first selected amount of supportive pressure; the user's thighs can each be individually supported with individual selected amounts of supportive pressure; and the user's back, arms, hands, or other body parts can each be individually supported with individual selected amounts of supportive pressure.

The control device can determine individual amounts of pressure exerted by the user's body parts on each individual distinct air element, to determine (1) information indicating whether the user is present on the cushion; (2) information indicating whether the user is attempting to enter/exit (“on-load” or “off-load”) the cushion; (3) information indicating whether the user is fidgeting, uncomfortable, asleep, or is subject to another medical condition; or otherwise as described herein. In response thereto, the control device can separately determine whether the user bottoms-out with respect to each individual distinct air element, and if so, what action to take (such as to adjust an air mass in one or more such individual distinct air elements, to assist the user in their attempt to onload/offload with respect to the cushion such as by adjusting each separate air element to urge the user to on-load or off-load the cushion, to indicate an alert to the user or to one or more caregivers or other persons, to separately adjust a selected minimum/maximum support pressure to provide safety against a bottoming-out event, or otherwise as described herein).

The user can direct the control device to override (such as by manually selecting a pressure, an amount of support, or otherwise as described herein) its adjustment of air mass in each separate air element. The user can provide one or more inputs to the control device, such as using an application (“app”) disposed with a smartphone or other mobile device, a control input coupled to the cushion or integrated into the cushion, another external device disposed to exchange one or more signals with the control device, communicating with one or more caregivers or other persons, or otherwise as described herein. The control device can also respond to one or more user activities, such as fidgeting or movement indicating discomfort (or otherwise indicating a pelvic obliquity, a pressure sore, a leaning/tilting position, or another medical condition), to adjust its control of one or more of the separate air elements and/or to indicate an alert to the user or to one or more caregivers or other persons, describing one or more detected conditions and one or more actions taken in response thereto. When the control device determines that one or more particular regions are at elevated risk for bottoming-out or other risk of pressure sores, the control device can take preventative action and can similarly indicate an alert to the user or to one or more caregivers or other persons, describing one or more detected conditions and one or more actions taken in response thereto.

### General Discussion

This general discussion is provided as an introduction to the description and does not limit or restrict the scope of the disclosure or the invention. This general discussion is intended as an introduction to more detailed description found in this Application, and as an overview of devices, systems, and methods described in this Application. The described techniques have applicability in other fields and beyond the embodiments specifically reviewed in detail.

### Pressurized Cushion and Control Device

As described herein, a system can include a pressurized cushion and a control device. The pressurized cushion can have multiple cells, each individually coupled to the control device, with the control device able to detect and/or control the pressure in each cell.

Each of the cells can include a cell bladder and a device disposed to measure the pressure imposed on the cell bladder. For example, the control device can be disposed to measure an air mass inflow/outflow with respect to the cell bladder, so that the control device can compute a measurement of pressure at a surface of the cell. Each of the cells can be disposed to have at least a portion of its pressure disposed to support a user, such as when the user is seated on the cushion, which is disposed on top of a support surface such as a wheelchair seat. For example, the control device can be disposed, as described herein, to adjust an air mass inflow/outflow with respect to the cell bladder, so that the cell can impose more/less pressure at its surface to support the user. The control device can select distinct individual cells to adjust a (static or dynamic) curvature of a surface supporting the user, or to attempt to move portions of the user's body to a relatively better position.

The control device can be disposed to detect one or more conditions which might affect the user of the cushion and can be disposed to adjust the pressure in one or more of those cells. The control device can also be disposed to present information about the system to the user (or a caregiver or medical personnel), and to receive information from the user (or the caregiver or medical personnel). The control device can use the information it determines in response to pressure in each cell, and/or the information it receives from the user (or the caregiver or medical personnel), to adjust the pressure in one or more cells to assist the user.

### Detecting and Responding to Conditions

For example, and without limitation, the control device can determine whether the user is actually present on the cushion and/or whether the user is attempting to lower themself onto the cushion or lift themself from the cushion. The control device can make this determination in response to a measurement of pressure on the cells, such as by: detecting the user's breathing or heartbeat; detecting fidgeting or other movement by the user; detecting attempts by the user to lift themself from, or lower themself onto, the cushion; or otherwise as described herein.

For example, and without limitation, the control device can determine whether the user remains in a relatively safe range above “bottoming out”, such as by: detecting a relative inflation of each of the cells and/or changes therein; or otherwise as described herein.

For example, and without limitation, the control device can determine whether the air pressure of an ambient environment changes, such as in response to airline flight or other change in altitude. A change in pressure from the ambient environment can induce a risk of either (A) the user “bottoming out” due to lack of internal pressure on the cushion's cells; or (B) the cushion over-inflating and possibly being damaged or causing the user to be uncomfortable or even fall off. In response thereto, the control device can adjust the internal pressure on the cushion's cells to mitigate the risk of the user “bottoming out”. For example, and without limitation, the control device can also determine whether the cushion is no longer in a state having a relatively safe range above the user “bottoming out” for any other reason, thus mitigating risk of the user sitting or lying directly on a hard support for any substantial amount of time.

For example, and without limitation, the control device can determine changes in pressure on individual cells indicate whether the user is moving or fidgeting.

The control device can determine whether that movement or fidgeting indicates an effort by the user to exit/enter a seated position on the cushion. In response thereto, the control device can adjust pressure on selected cells to assist the user in exiting/entering their selected position on the cushion.

The control device can also determine whether that movement or fidgeting indicates an effort by the user to obtain a more comfortable position (whether due to a possible cramp or other medical condition or due to a possible misconfiguration of pressure on individual cells of the cushion). In response thereto, the control device can adjust pressure on selected cells to assist the user in obtaining a relatively comfortable position and can record information about (or from) the user helping the control device to maintain a relatively comfortable position for the user at later times.

The control device can determine whether that movement or fidgeting indicates that the user is in the process of, or in relative danger of, slipping off the cushion and possibly falling on the floor (or any other hard surface), or otherwise leaning or sliding in a relatively unsafe manner. In response thereto, the control device can adjust pressure on selected cells to assist the user in maintaining their safe position supported by the cushion and can record information about (or from) the user helping the control device to maintain a relatively safe position for the user at later times.

For example, and without limitation, the control device can determine whether the pressure provided the cushion's cells change for any other reason.

In response to possible leakage from a cell bladder, the control device can provide an alert to the user (or to the caregiver or medical personnel) and can, at least temporarily, adjust the internal pressure provided to that cell bladder to compensate for that possible leakage.

In response to a change in weight applied by the user, such as when the user has gained/lost substantial body weight, or such as when the user is holding a package or a pet on their lap while seated on the cushion, the control device can adjust the internal pressure provided to selected cell bladders to compensate for that change in weight.

The following terms and phrases are exemplary only, and not limiting.

The phrases “this application”, “this description”, “this specification”, and variants thereof, generally refer to any material shown or suggested by any portions of this Application, individually or collectively, and including all inferences that might be drawn by anyone skilled in the art after reviewing this Application, including all inferences that might be drawn by anyone skilled in the art using information developed or disclosed after the filing of this Application, even if that material would not have been apparent without reviewing this Application at the time it was filed.

### External Devices

The phrases “handheld computing device”, “handheld phone”, “mobile computing device”, “mobile device”, and variants thereof, generally refers to any relatively portable device disposed to receive inputs from and provide outputs to, one or more users. For example, a mobile device can include a smartphone or cellular phone, an MP3 player, a laptop or notebook computer, a computing tablet or phablet, or any other relatively portable device disposed to be capable as further described herein. The mobile device can include input elements such as a capacitive touchscreen; a keyboard; an audio input; an accelerometer or haptic input device; an input couplable to an electromagnetic signal, to an SMS or MMS signal or a variant thereof, to an NFC or RFID signal or a variant thereof, to a signal disposed using TCP/IP or another internet protocol or variant thereof, to a signal using a telephone protocol or a variant thereof; another type of input device; or otherwise.

The phrases “remote device”, “logically remote device”, “physically remote device”, and variants thereof, generally refers to any device disposed to be accessed, and not already integrated into the accessing device, such as possibly disposed to be accessed by an optics device or another device. For example, a remote device can include a database or a server, or another device or otherwise, such as coupled to a communication network or accessible using a communication protocol. For another example, a remote device can include one or more mobile devices operating either individually or collectively, such as accessible using one or more of: a telephone protocol, a messaging protocol such as SMS or MMS or a variant thereof, an electromagnetic signal such as NFC or RFID or a variant thereof, an internet protocol such as TCP/IP or a variant thereof, or otherwise.

The phrases “user input”, “user input device”, “input device”, and variants thereof, generally refers to information received from the user, such as in response to audio/video conditions, requests by other persons, or otherwise. For example, user input can be received in response to an input device (whether real or virtual), a gesture, using a smartphone or controlling device, or otherwise.

### Cushion

The term “cushion”, and variants thereof, generally refers to any device(s), individually or collectively, that might be disposed to support (or otherwise used, such as disposed to massage, restrain, or otherwise) a patient or other user, and suitable to provide a relatively safe position for the user when sitting, lying down, or otherwise relatively motionless or having restrained freedom of movement, so as to prevent the user from developing sores, cramps, seating fatigue, or related effects.

Cushions can include one or more of: active padding (as defined herein) or other soft covering disposed to protect a user from hard surfaces or other impact, the hard surfaces possibly being arrayed on a chair (such as a seat), a bed, or another item of furniture, a bulkhead or wall (such as in an aircraft or other vehicle), a piece of equipment (such as an x-ray device, medical equipment, scientific equipment, exercise equipment, robotic equipment, any other delicate or sensitive device, any other resistive surface), or as otherwise described herein.

The phrase “active padding”, and variants thereof, generally refers to any device(s), individually or collectively, that might be controlled to adjust an amount of resistance and/or pressure at a point of contact with a user, such as possibly when the user is sitting or lying down, or using a neck brace or other immobilizing device for one or more body parts, a device for physical resistance or medical testing, or as otherwise described herein.

The term “cell”, and variants thereof, generally refers to any portion of the cushion, individually or collectively, that might be disposed to support (or otherwise used, such as disposed to massage, restrain, or otherwise) a patient or other user, and suitable to provide a relatively safe position for the user when sitting, lying down, or otherwise relatively motionless or having restrained freedom of movement, so as to prevent the user from developing sores, cramps, seating fatigue, or related effects.

The phrase “control device”, and variants thereof, generally refers to any device capable of receiving information with respect to measurements from a cushion (such as possibly pressure measurements at selected points of contact with a user), capable of determining one or more conditions with respect to the user and/or equipment (such as possibly too-close contact between the user and a hard surface), or capable of adjusting the active padding (such as adjusting the pressure of selected cells on portions of the user's body) to maintain a selected condition (such as a position with the user being relatively safe from pressure sores or other untoward effects from pressure on a hard surface for an extended duration).

The phrase “internal pressure”, and variants thereof, generally refers to any measure of pressure exerted by the air mass on an external surface of the cushion, or a similar measure of force exerted by the cushion to support a user. The cushion might change the amount of force exerted to support a user in response to one or more factors, such as fidgeting or other movement by the user, entry/exit of the cushion by the user, or otherwise as described herein.

The phrase “external pressure”, and variants thereof, generally refers to any measure of pressure exerted by an ambient environment, such as a pressure from the atmosphere. Atmospheric pressure can vary from time to time in response to changes in altitude, weather, or other effects.

### Medical Conditions

The phrase “medical condition”, and variants thereof, generally refer to any physical, psychological, emotional, or other conditions, whether generally treated by medical personnel or other personnel. For example, while this Application primarily refers to pressure sores, there is no particular requirement for any such limitation. For example, medical conditions can refer to any other disorders related to limited mobility by the user, whether imposed by bodily inability or by constraint to a particular location or position.

The phrase “user condition”, and variants thereof, generally refers to any condition, or measure thereof, detectable by sensors, user self-reports, or observation of the user. For example, user conditions can include pressure sores, user head or body movement, user speech/vocalization, observations of user by medical personnel or emergency responders, and otherwise.

### Monitoring and Treatment

The phrase “real time”, and variants thereof, generally refers to any function or operation performed without substantial delay, such as without a significant processing delay. For example, determining information in real time can include making the determination within a time period not recognizable as delay by a human patient. For another example, determining a likelihood of an upcoming event (such as the user falling or slipping from the cushion) in real time can include making the determination within a time period substantially before the actual upcoming event.

The phrase “real time”, and variants thereof, can refer to timing, particularly with respect to sensory input or adjustment thereto, operating substantially in synchrony with real world activity, such as when a user is performing an action with respect to real world sensory input.

The phrases “signal input”, “external signal input”, and variants thereof, generally refer to any input detectable by a control device, a remote device, or other devices. For example, in addition to or in lieu of sensory inputs and external sensory inputs, signal inputs can include one or more of:
information available to the control device or the remote device in response to electromagnetic signals other than human senses, such as signals disposed in a telephone protocol, a messaging protocol such as SMS or MMS or a variant thereof, an electromagnetic signal such as NFC or RFID or a variant thereof, an internet protocol such as TCP/IP or a variant thereof, or similar elements;
information available to the control device or the remote device in response to an accelerometer, a gyroscope, a GPS signal receiver, a location device, an ultrasonic device, or similar elements;
information available to the control device or the remote device in response to a magnetometer, a medical imaging device, an MRI device, a tomography device, or similar elements;
or otherwise as described herein.

### Other Terms and Phrases

The terms “pseudo-random”, “random”, and variants thereof, generally refers to any process or technique having a substantially nonpredictable result, such as when viewed by an external observer or an observer not having details of an algorithm or a key for that process or technique. For example, encryption and/or obfuscation techniques can be considered pseudo-random in the context of techniques described herein. The term “random”, and variants thereof, can include pseudo-random processes and functions, and can also include any process or technique having a physical and/or informational element involving chance or probability, such as a stochastic element or such as a measurement of a quantum mechanical process.

The phrase “user input”, and variants thereof, generally refers to information received from the user, (such as in response to medical or comfort conditions), requests by other persons (such as a caregiver or other personnel), or otherwise. For example, user input can be received by the control device or the remote device in response to an input device, or otherwise), using a smartphone or controlling device, or otherwise.

The phrase “user parameters”, and variants thereof, generally refers to information with respect to the user as determined by the control device, in response to user input, or other information about the user. For example, user parameters can include measures of whether the user is comfortable, in a relatively safe position with respect to “bottoming out” on a relatively hard surface, whether the user is currently undergoing a fall or slippage from the cushion (such as from lack of balance), a measure of confidence or probability thereof, a measure of severity or duration thereof, other information with respect to such events, or otherwise.

### Interpretation

After reviewing this Application, those skilled in the art would recognize that these terms and phrases should be interpreted in light of their context in the specification.

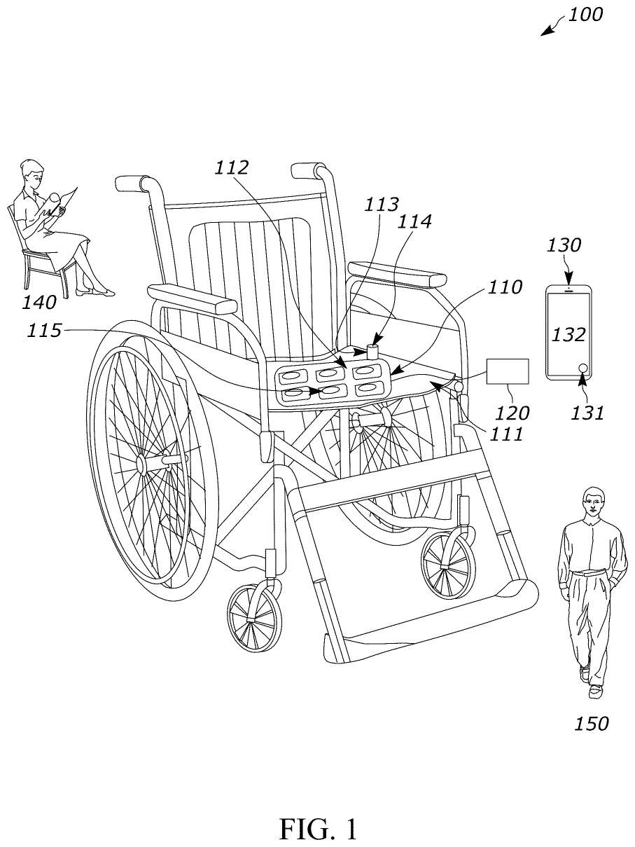

FIG. 1 shows a conceptual drawing of an example system including a support cushion and control device.

FIG. 1 is described with respect to at least the following elements:
100—system;
110—cushion, 111—hard surface, 112—cells, 113—pump, 114—vent, 115—sensor;
120—control device; 130—remote device, 131—input, 132—display;
140—user (not part of system); and
150—caregiver, medical or other personnel (not part of system).

### System Elements

As described herein, the system 100 can include a cushion 110 and a control device 120. The cushion 110 can rest on a hard surface 111 and include one or more cells 112 disposed to exert pressure to support the user 140 (not part of the system). The system 100 can include a pump 113 and/or a vent 114 disposed to provide air inflow/outflow with respect to the cell 112. Alternatively, the pump 113 can be disposed to operate to provide air outflow with respect to the cell 112, or can include or be supplemented with a vacuum pump disposed to remove air from the cell 112. The system 100 can include a sensor 115 disposed to provide a measure of pressure and/or air mass with respect to the cell 112.

The control device 120 can include a processor (not shown) operating under control of application software (not shown). The control device 120 can be coupled to a remote device 130 and disposed to exchange information with the remote device 130 to exchange information with the user 140 and/or a caregiver or other personnel 150. Either the control device 120 or the remote device 130, or both, can include a smartphone or other mobile device, or some combination of more than one such device. For example, the user 140 and/or a caregiver or other personnel 150, can couple a smartphone to the system 100 and exchange information with the control device 120, such as described herein. The user 140 or the caregiver or medical personnel 150 can receive alerts, provide information about the user 140, or otherwise exchange information with the system 100 as described herein.

While the system 100 is described herein with respect to a pump 113 (possibly including or supplemented with a vacuum pump), vent 114, and sensor 115 for each cell 112, there is no particular requirement for any such limitation. It is possible to use one or more pumps 113 or one or more vacuum pumps, less than the number of cells 112, and to distribute the use of the one or more pumps 113 each for use with one or more cells 112. For example, a single pump 113 can be coupled to each of several selected cells 112 in turn, with the effect of providing the function of that pump 113 to all of those cells 112 without requiring a separate pump 113 for each such cell 112. Similarly, a single vent 114 or a single sensor 115 can be coupled to each of several selected cells 112 in turn, with the effect of providing the function of that vent 114 or sensor 115 to all of those cells 112 without requiring a separate vent 114 or sensor 115 for each such cell 112.

The control device 120 can be coupled to the one or more pumps 113 and vents 114 and disposed to cause selected ones of those pumps 113 and vents 114 to perform their function for selected cells 112. The control device 120 can be coupled to the one or more sensors 115 and disposed to receive information from selected cells 112. For example, the control device 120 can be disposed to receive information from selected cells 112 with respect to the pressure exerted by those cells 112 on the user 140, and to provide control signals to selected pumps 113 and vents 114 to adjust the pressure exerted by those cells 112.

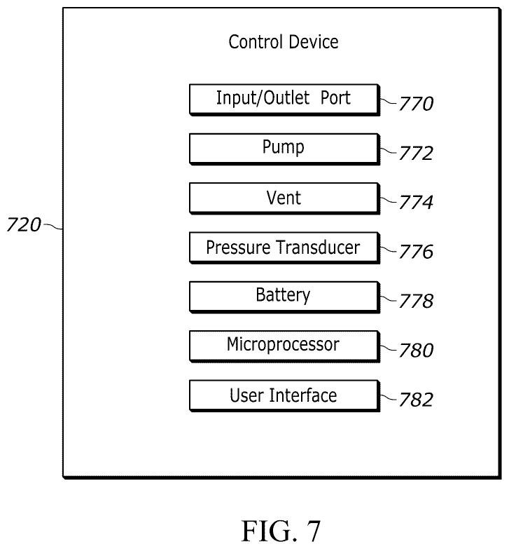

In an example, the control device 120 includes a pump 113, a vent 114, at least one sensor 115, and a processor and memory. In an example, the control device 120 is configured to implement the system functions described herein. In an example, the cushion 110 includes on a single bladder (e.g., cell 112) that pneumatically connected to a control device by a single hose. The control device is configured to sensor pressure in the bladder via the sensor 115 located within the bladder and to inject air into the bladder via the pump 113 or expel air through the vent 114, both of which are also included within the control device 120. An example of a control device that includes an inlet/outlet port, a pump, a vent, a battery, a microprocess, and a user interface is described with reference to FIG. 7.

### System Functions

As described herein, the control device 120 can exchange at least the following information with the cushion 110: User size or weight.

In one embodiment, the control device 120 can receive information from the sensors 115 with respect to an amount of pressure on each of the cells 112. The control device 120 can operate the one or more pumps 113 and vents 114 to cause an amount of air mass in selected cells 112 to have a known pressure without any object weighing on the cushion 110. When the sensors 115 measure the pressure on selected cells 112 with the user 140 positioned on a surface of the cushion 110, the control device 120 can receive the “with-user” pressure and determine a difference from the “without-user” pressure. With information with respect to the difference between the with-user pressure and the without-user pressure, the control device 120 can determine a size and weight of the user 140.

For example, the control device 120 can determine a size of the user 140 in response to identifying a set of cells 112 upon which the user's weight imposes pressure and an amount of pressure imposed on those cells 112. The control device 120 can determine a region including those cells 112 upon which the user's weight imposes pressure, measure one or more widths of that region at selected cross-sections, and determine one or more measures of the user's size in response thereto.

For example, the control device 120 can determine a weight of the user 140 in response to identifying a difference between the pressure on selected cells 112 as measured with the user's presence (a “with-user” pressure) and as measured without the user's presence (a “without-user” pressure). The control device 120 can look up a user's likely weight in a pre-determined table indexing one or more of: the difference between the with-user pressure and the without-user pressure, the determined size of the user 140, or an estimated user's weight received from an input 131 at the remote device 130. The control device 120 can present information with respect to the user's size or weight on a display 132 at the remote device 130.

The control device 120 can exchange information with the user 140, and/or a caregiver or other personnel 150, with respect to a user's size and weight. The user 140, or caregiver or medical personnel 150, can use this information with respect to medical diagnosis or treatment, or can use this information to calibrate the system 100. For example, if the control device 120 presents a determined user's weight that is 10% lower than the user's own measurement, the control device 120 can receive that information from an input 131 at the remote device 130. The control device 120 can adjust its calibration of one or more of the pumps 113, vents 114, or sensors 115, in response thereto.

As described herein, the control device 120 can use information about a difference between its own measurement of the user's size or weight and the user's or caregiver's measurement of the user's size or weight to adjust its treatment of other data with respect to the user 140. In response to a change in weight applied by the user 140, such as when the user 140 has gained/lost substantial body weight, or such as when the user 140 is holding a package or a pet on their lap while seated on the cushion 110, the control device 120 can adjust the internal pressure provided to selected one or more cells 112 to compensate for that change in weight.

### User Input of Preferred Pressure.

In one embodiment, the control device 120 can receive information from the user 140, such as using the input 131 at the remote device 130, to allow the user 140 to select one or more preferred amounts of pressure, such as a preferred pressure when the user 140 is entering/exiting a sitting position on the cushion 110, a preferred pressure when the user 140 is adjusting their position on the cushion 110, or a preferred pressure in a different context when the user 140 is operating with the cushion 110.

Similarly, the control device 120 can use information about the difference between its own measurement of the user's size or weight and the user's or caregiver's measurement of the user's size or weight to adjust its selected setpoints for a selected pressure to use when the user 140 is entering/exiting a sitting position on the cushion 110, a selected pressure when the user 140 is adjusting their position on the cushion 110, or a selected pressure in a different context when the user 140 is operating with the cushion 110.

### Assisting User Entering/Exiting Cushion.

The control device 120 can determine whether the user 140 is entering/exiting a location on top of the cushion 110 (or, for some configurations, to a side of the cushion 110). The control device 120 can receive information with respect to the user 140, such as a signal from the user 140 indicating that the user 140 is ready to enter/exit (usually exit) the cushion 110. Alternatively, the control device 120 can determine, in response to changes in pressure on one or more of the cells 112, whether the user's weight is moving on a path indicating that the user 140 is entering/exiting (usually exiting) a location on top of (or to the side of) the cushion 110. In response thereto, the control device 120 can adjust the pressure of selected one or more cells 112 to assist the user 140 with the process of entering/exiting the location on top of (or to the side of) the cushion 110. For example, the control device 120 can over-inflate the cushion 110, or over-inflate one or more rear cells 112 of the cushion 110, to assist the user 140 with exiting.

For example, in response to determining that the user 140 is entering the location on top of the cushion 110, the control device 120 can reduce the pressure on selected cells 112, below a “normal” associated pressure, of those cells 112 located on a path toward where the user 140 would be seated, thus providing an easier path for the user 140 to move into a seated location on top of the cushion 110. Similarly, in response to determining that the user 140 is exiting the location on top of the cushion 110 (sometimes referred to herein as an “offload”), the control device 120 can increase the pressure on selected cells 112, above a “normal” associated pressure, of those cells 112 located from where the user 140 is moving, thus assisting the user 140 is moving off the cushion 110, and decrease the pressure on selected cells 112, below a “normal” associated pressure, thus providing an easier path for the user 140 to move off the cushion 110.

Similarly, the control device 120 can assist the user 140 with maintaining their posture while located on top of (or to the side of) the cushion 110. In response to determining a location where the user 140 is positioned on top of the cushion 110, the control device 120 can determine whether the user's posture is disposed properly. For example, the control device 120 can determine whether the user 140 is leaning to one side when seated on top of the cushion 110, such as by comparing the pressure (or changes in pressure) with respect to more than one cell 112 or zone of the cushion 110. When the user 140 is leaning to one side when seated on top of the cushion 110, the control device 120 can adjust the pressure on selected cells 112 or zones of the more than one such cells 112 or zones to push the user 140 toward a sitting disposition that is closer to an upright posture.

Similarly, the control device 120 can measure changes in pressure on individual cells 112 and determine whether those changes indicate the user 140 is attempting to enter/exit their position on the cushion 110, or is otherwise moving or fidgeting, or whether the user 140 is leaning or otherwise moving. The control device can determine whether that movement or fidgeting indicates an effort by the user 140 to exit/enter a seated position on the cushion 110. When the user 140 is attempting to enter/exit their selected position on the cushion 110, the control device 120 can adjust pressure on selected one or more cells 112 to assist the user 140.

When the user 140 is otherwise moving or fidgeting, the control device 120 can adjust pressure on selected one or more cells 112 to provide the user 140 with greater comfort while seated (as might be indicated by cessation in moving or fidgeting, or by user input to the remote device 130 indicating that the user 140 is more comfortable). In such cases, the control device 120 can record information about (or from) the user 140 to help the control device 120 to maintain a relatively comfortable position for the user 140 at later times.

In some cases, the user's movement might indicate that the user 140 is in the process of, or in relative danger of, slipping off the cushion 110 and possibly falling on the floor (or any other hard surface), or otherwise leaning or sliding in a relatively unsafe manner. In response thereto, the control device 120 can adjust pressure on selected one or more cells 112 to assist the user 140 to maintain a relatively safe and balanced position supported by the cushion 110 and selected one or more of its cells 112, and can record information about (or from) the user 140 as described with respect to the user's comfort or safety.

### Adjusting Due to Ambient Pressure Changes.

In one embodiment, the control device 120 can receive information from one or more of the cells 112, such as reported by sensors 115 associated with those cells 112. The sensors 115 can include a sensor for an external pressure (such as atmospheric pressure). Alternatively, the control device 120 can determine the atmospheric pressure in response to changes in internal pressure which have no corresponding changes to the user's size and weight.

When the pressure changes with respect to one or more selected cells 112, but there has been no change in pressure from an ambient environment, the control device 120 can determine whether the change in pressure provided by those cells 112 is due to leakage of one or more such cells 112. In such cases, the control device 120 can provide an alert to the user 140 (or to the caregiver or medical personnel) and can, at least temporarily, adjust the internal pressure provided to that cell bladder to compensate for that possible leakage.

Keeping the User within Safe Range.

In one embodiment, the control device 120 can receive information from one or more of the cells 112, such as reported by sensors 115 associated with those cells 112. The control device 120 can use this information to determine whether the user 140 is within a relatively “safe” range to avoid the risk of the user 140 “bottoming out”, which can occur when the cushion 110 (or one or more of its cells 112) is insufficiently inflated and allows the user 140 to fall to a hard surface 111 and exert pressure on their muscles, nerves, and other body parts. Excess pressure from the hard surface 111 can cause pressure injuries, so the user 140 remains within a relatively “safe” range only when the possibility of falling to the hard surface 111 is minimal or nearly nil.

When the control device 120 determines that the user 140 is within the relatively safe range, it can maintain the pressure associated with selected one or more cells 112, so as to maintain the pressure within that range. In contrast, when the control device 120 determines that the user 140 is not within the relatively safe range, it can adjust the pressure associated with selected one or more cells 112, so as to cause the pressure to move the user 140 into a relatively safe range.

When the user 140 moves, such as when the user 140 attempts to enter/exit the cushion 110, or such as when the user 140 fidgets or otherwise moves while seated (or lying) on the cushion 110, the control device 120 can periodically (or aperiodically, or randomly or pseudo-randomly) re-receive information with respect to the user's position in or out of the relatively safe range. The control device 120 can determine whether the user 140 has remained in the relatively safe range, whereupon the control device 120 need not take any particular special action, or whether the user 140 has moved out of the relatively safe range, whereupon the control device 120 can adjust the pressure of selected one or more cells 112 to urge the user 140 back into the relatively safe range.

The control device 120 can cause its adjustment of pressure for the selected one or more cells 112 so as to maintain the user's position below a selected ceiling, thus, not so high above “bottoming out” that the user 140 is at risk of falling or sliding off the cushion 110.

### User Preset Values for the Cushion.

In one embodiment, the control device 120 can receive information from the user 140, such as using the remote device 130, a smartphone or other mobile device, or another technique. The information from the user 140 can include one or more selected “preset” parameters describing the user's preferences for the cushion 110, possibly including a preferred firmness, a preferred height above the supporting hard surface, a preferred responsiveness to the user's fidgeting or movement, a preferred amount of assistance when the user 140 attempts to enter/exit a sitting (or lying down) location on top of (or to a side of) the cushion 110, a contact for a caregiver or medical personnel in the event the user 140 becomes unable to reach the cushion 110 or becomes injured, or otherwise as described herein.

The control device 120 can maintain a selected group of preset parameters for a selected one or more users 140, such as for each one of a set of individual users, for each one of a set of groups of users, or otherwise as described herein. For each such selected one or more users, the control device 120 can maintain one or more such preset parameters, such as for selected different circumstances in which the cushion 110 is maintained for the user's convenience.

For example, each user 140 (or selected set of users 140) can maintain a first set of preset parameters when using the cushion with a wheelchair, a second set of preset parameters when using the cushion when seated as a passenger in an automobile or airliner, a third set of preset parameters when using the cushion when operating an vehicle (such as an automobile, a motorboat, or otherwise as described herein), and other sets of preset parameters as selected by the user 140.

For example, each user 140 (or selected set of users 140) can maintain a particular set of preset parameters associated with uses for which the user 140 expects a relatively substantial amount of vibration or other risk of “bottoming out”, a particular set of preset parameters associated with uses for which the user 140 expects that intentional overinflation is preferred, a particular set of preset parameters associated with a selected set of pressure ranges for each selected user 140, or otherwise as described herein.

For example, the control device 120 can maintain a particular set of preset parameters for each user 140 (or selected set of users 140), which the control device 120 can lock to prevent individual users 140 from accidentally or otherwise altering.

The control device 120 can maintain a selected group of preset parameters associated with the cushion 110, so as to allow a selected one or more users 140 to approach the cushion 110, select their particular preferred set of parameters from a set of preloaded selected parameters, and thereafter use the cushion 110 as if the cushion 110 was personalized to that particular user 140. For example, a single cushion 110 or control device 120 might be used with a set of profiles each associated with selected users 140, with the effect that a group of selected users 140 (such as residents of a nursing home or other group living arrangement) can each use the same cushion 110 as if it was personalized when the cushion 110 was assigned to a particular user 140.

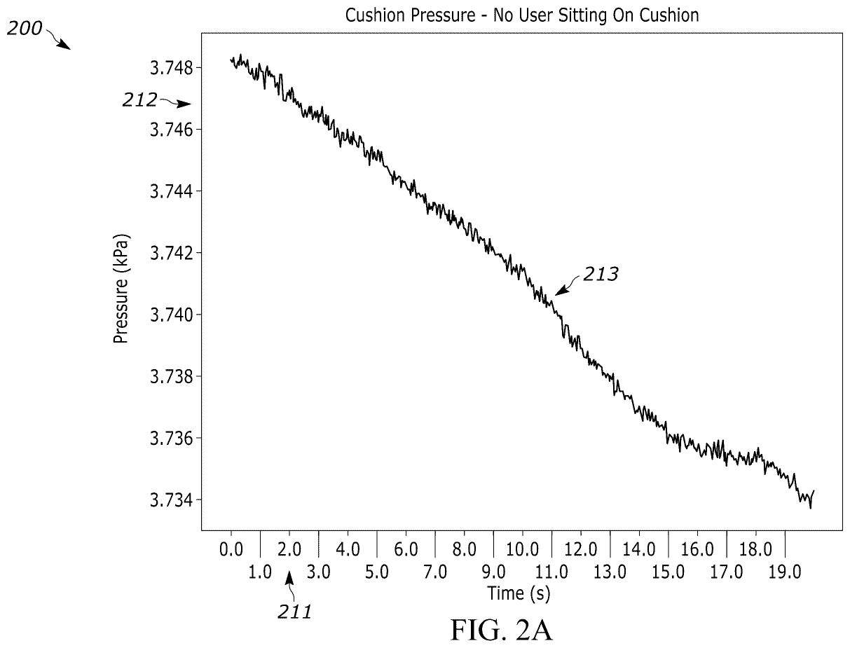

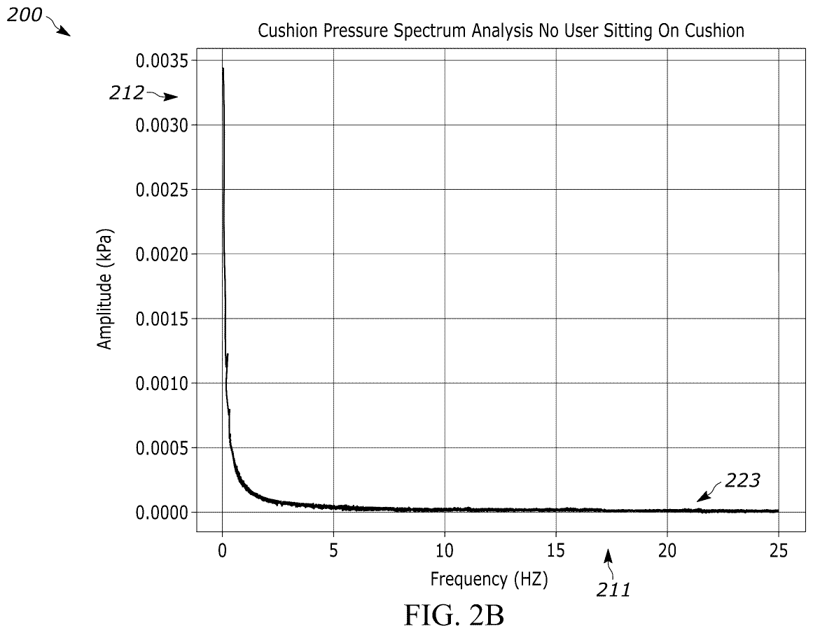

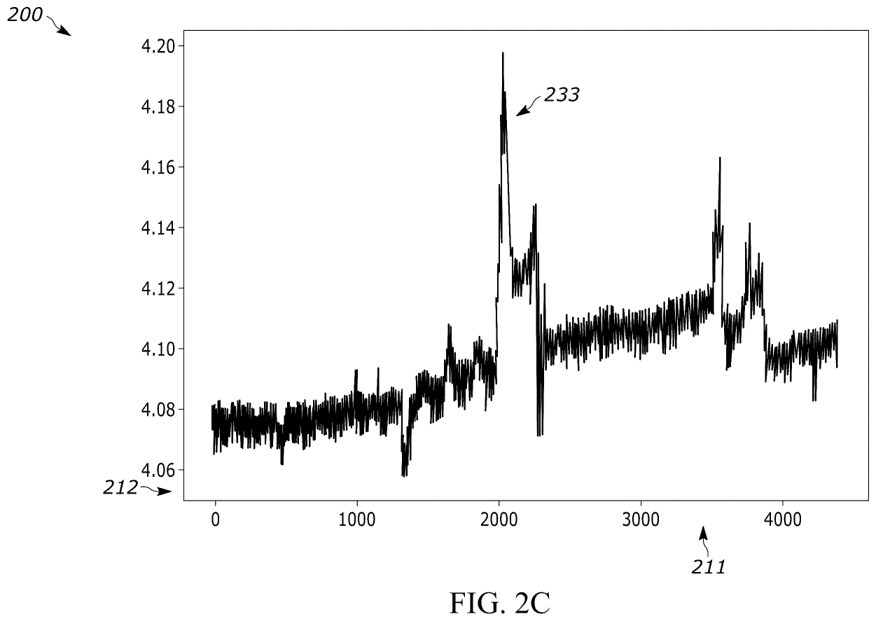

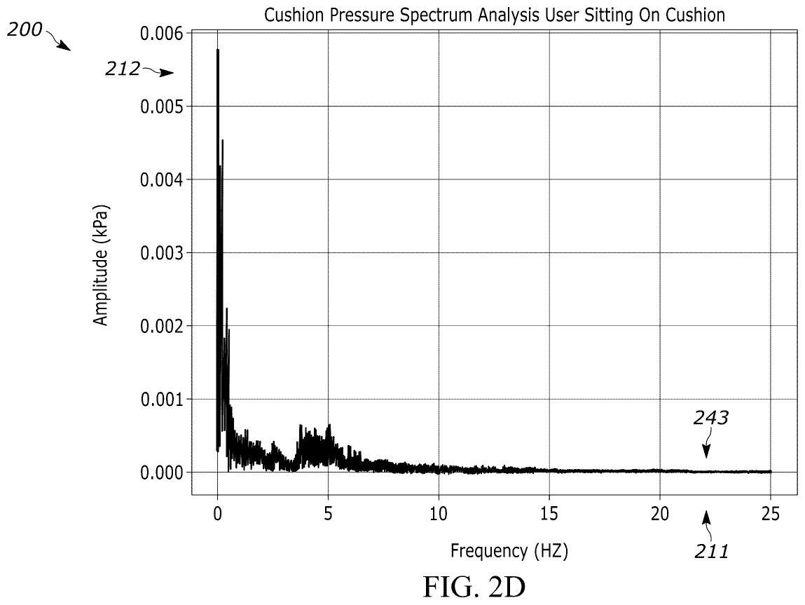

FIGS. 2A-2D illustrate an example set of measurements of pressure using a support cushion.

FIG. 2A is described with respect to at least the following elements:
200—pressure measurement graph; and
211—X axis (time), 212—Y axis (pressure), 213—pressure without user.

FIG. 2B is described with respect to at least the following elements:
200—pressure measurement graph; and
211—X axis (frequency), 212—Y axis (relative energy), 223—energy without user.

FIG. 2C is described with respect to at least the following elements:
200—pressure measurement graph;
211—X axis (time), 212—Y axis (pressure), 233—pressure with user.

FIG. 2D is described with respect to at least the following elements:
200—pressure measurement graph; and
211—X axis (frequency), 212—Y axis (relative energy), 243—energy with user

### Detecting User Presence on Cushion

The control device 120 can receive information from the user 140, such as the user's size or weight, as described herein with respect to measurements of pressure on one or more of the cells 112, such as reported by sensors 115 associated with those cells 112. The control device 120 can determine a signal indicating whether the user's size or weight varies with time, such as in response to the user's breathing or heartbeat. For example, when the user 140 breathes in/out or when the user's heartbeat occurs, the signal indicating the user's measured size or weight should be subject to substantial noise as measured by a pressure sensor. In response to this noise, the control device 120 can determine whether a user 140 is currently located on the cushion 110. In response to whether the user 140 is currently located on the cushion 110, the control device 120 can determine what control signals to apply to the one or more of the pumps 113 or vents 114 and can determine what measurements received from the sensors 115 are normal when the user is present, or abnormal when the user is absent.

### Detecting User Heartbeat, Breathing, or Wheelchair Vibration (I)

FIG. 2A shows a pressure measurement graph comparing an X axis 211 (describing a time value or a count of a number of pressure measurement data points) and a Y axis 212 (describing a pressure value or a sensor value responsive to a pressure value). In the FIG. 2A, a pressure graph 213 describes a pressure value 212 as measured without a user substantially present on the cushion 110.

The control device 120 can receive information from the cushion 110, such as a time-varying pressure as for example shown on the Y axis 212 (possibly measured with respect to a count of data points as for example shown on the X axis 211, each determined after a relatively consistent time duration), with respect to pressure measurements with respect to one or more of the cells 112. While this Application primarily describes pressure measurements with respect to one or more of the cells 112, there is no particular requirement for any such limitation; for example, at least some of the pressure measurements can be determined with respect to a combination or conjunction of more than one of the cells 112.

The control device 120 can perform a process with respect to the measurement of time-varying pressure as determined by one or more sensors coupled to the cushion 110.

FIG. 2B shows a frequency transform of the pressure graph 213 comparing an X axis 211 (describing a time value or a count of a number of pressure measurement data points) and a Y axis 212 (describing a relative energy at a frequency of the pressure value or the sensor value responsive to a pressure value). In the FIG. 2B, a pressure frequency graph 223 describes relative energies of pressure frequencies as measured without a user substantially present on the cushion 110.

When the user is substantially not present on the cushion 110, the relative energies of pressure frequencies will be substantially entirely at a zero frequency; thus, the pressure value will not change with any user heartbeat or breathing rate. Similarly, when the user is not using the wheelchair, the pressure value will not change with any movement by the user activating the wheelchair or riding over any rough surfaces.

While it is possible that the wheelchair will “run away” from the user and will exhibit some pressure differences from riding over any rough surfaces, this is expected to be unusual and to be detectable by other techniques.

### Detecting User Heartbeat, Breathing, or Wheelchair Vibration (II)

FIG. 2C shows a pressure measurement graph 200 comparing an X axis 211 (describing a time value or a count of a number of pressure measurement data points) and a Y axis 212 (describing a pressure value or a sensor value responsive to a pressure value). In the FIG. 2C, a pressure graph 233 describes a pressure value as measured with a user present on the cushion 110.

The control device 120 can receive information from the cushion 110, such as a time-varying pressure as for example shown on the Y axis 212 (possibly measured with respect to a count of data points as for example shown on the X axis 211, each determined after a relatively consistent time duration), with respect to pressure values with respect to one or more of the cells 112. While this Application primarily describes pressure values with respect to one or more of the cells 112, there is no particular requirement for any such limitation; for example, at least some of the pressure values can be determined with respect to a combination or conjunction of more than one of the cells 112.

The control device 120 can perform a process with respect to the measurement of time-varying pressure as determined by one or more sensors coupled to the cushion 110.

### Frequency Transform of Pressure Changes

FIG. 2D shows a frequency transform of the pressure graph 233 comparing an X axis 211 (describing a time value or a count of a number of pressure measurement data points) and a Y axis 212 (describing a relative energy at a frequency of the pressure value or the sensor value responsive to a pressure value). In the FIG. 2D, a pressure frequency graph 243 describes relative energies of pressure frequencies as measured with a user substantially present on the cushion 110.

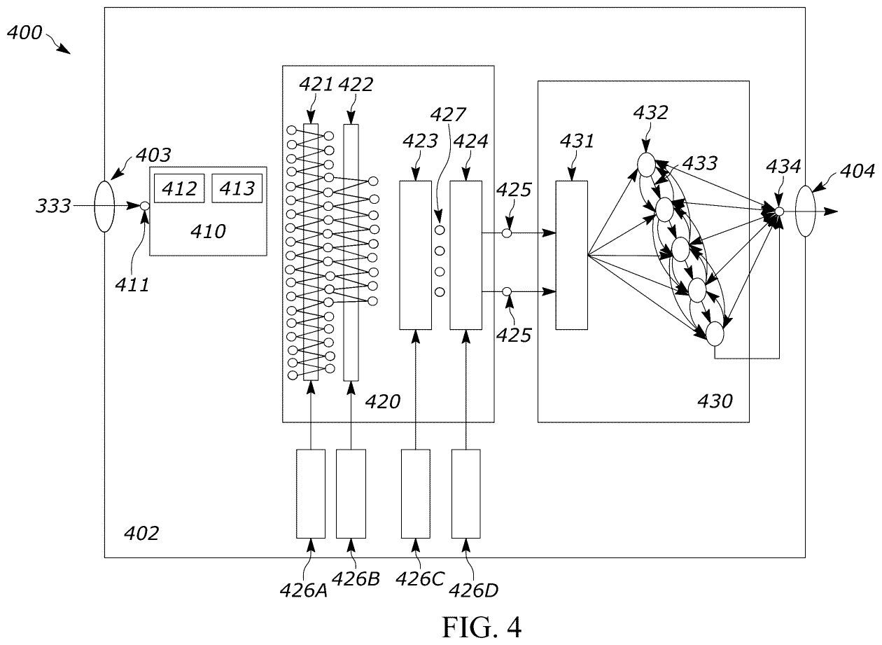

To provide a sequence of input data to the neural network (described with respect to FIG. 4), the control device 120 can receive information including a time-varying pressure. The control device 120 can perform data cleaning, such as by removing outlier values and possible sensor errors. The control device 120 can determine a moving average, as described herein, and can subtract that moving average from the time-varying pressure values. This can allow the neural network to be responsive to a sequence of pressure values with a zero baseline. The control device 120 can also perform any further desired filtering. This can provide a sequence of pressure values to the neural network, which can determine a confidence value with respect to whether a user heartbeat is present, as described herein.

In one embodiment, the control device 120 can determine a moving average of the time-varying pressure determined by the one or more sensors coupled to the cushion 110. In one embodiment, the moving average includes a simple moving average, but there is no particular requirement for any such limitation. For example, the moving average can include a weighted moving average, an exponential moving average, or a combination or conjunction thereof. As shown in the FIG. 2C, the pressure measurements 212 can vary substantially when the user fidgets, moves, or attempts to on-load or off-load with respect to the cushion 110. Determining the moving average can have the effect of avoiding merely identifying all low-pressure states with the user being absent and identifying all high pressure states with the user being present. Similarly, determining the moving average can have the effect of allowing the heartbeat detector to respond to the presence of noise in the input signal.

The control device 120 can perform a filter operation on the moving average of the time-varying pressure. In one embodiment, the filter operation includes removing frequencies which are much too high to be associated with a heartbeat and are believed to be sensor noise. In combination with determining the moving average of the of the pressure signal, this provides a bandpass filter which removes large changes in pressure and allows the heartbeat detector to be responsive to the presence of noisiness in the input signal.

While this Application primarily describes a heartbeat detector which filters its input signal using (A) a moving average, and (B) a filter to remove sensor noise, there is no particular requirement for any such limitation. For example, there is no particular requirement to filter the input signal either before or after using a neural network (as described herein) to detect a confidence that the user 140 is present on the cushion 110, as the neural network can perform at least some filtering or can perform detection without need for filtering. For another example, the heartbeat detector can determine whether the input signal “looks like” a heartbeat without necessarily filtering that input signal either before or after determination.

While this Application primarily describes a heartbeat detector which filters its input signal with respect to selected frequencies, there is no particular requirement to limit those selected frequencies to frequencies expected for the speed of the heartbeat itself; the selected frequencies need not be limited to frequencies such as about 60-80 beats/minute (bpm) (e.g., within +10%) for heart rate and 10-20 (e.g., within +10%) breaths/minute for breathing. There can be other frequencies which are relevant to determining whether the input signal includes a heartbeat, such as possibly (A) frequencies associated with faster or slower heartbeats; (B) frequencies associated with the waveform of an individual heartbeat, e.g., a QRS complex or another sinus rhythm; (C) harmonics of these or other relevant frequencies, or otherwise as described herein. Similarly, a breathing detector might be disposed to be responsive to frequencies other than the user's expected breathing rate.

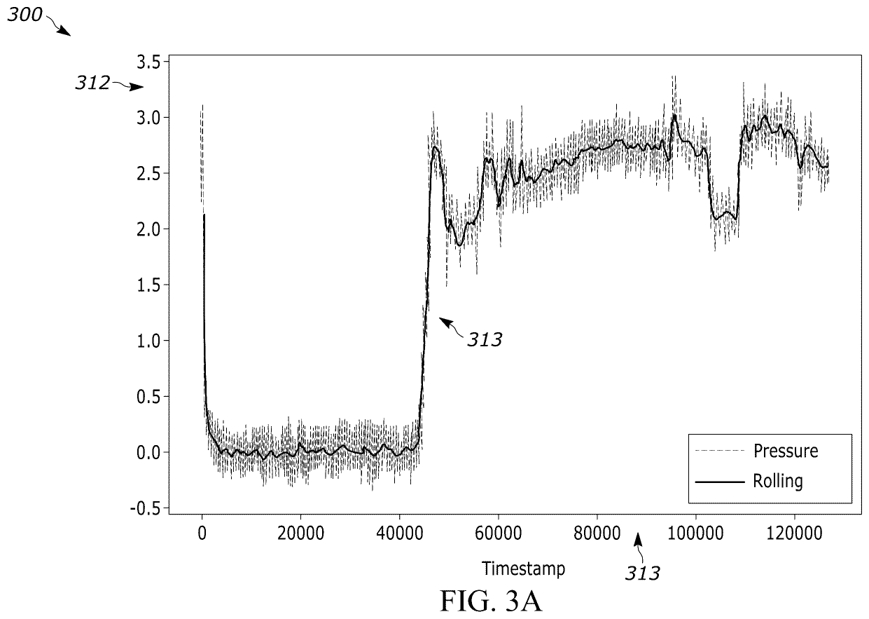

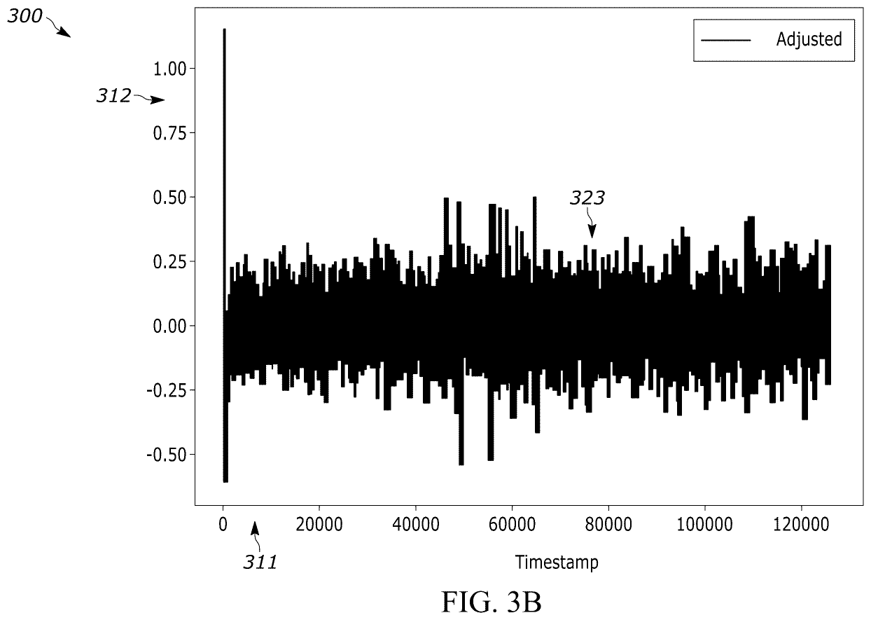

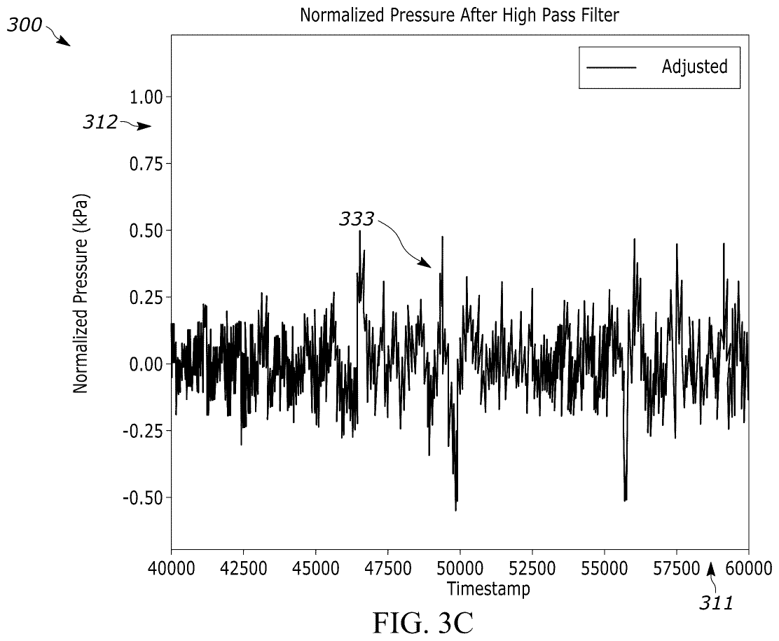

FIGS. 3A-3C illustrate example data used with respect to a heartbeat-detection system.

FIG. 3A shows a conceptual drawing of unfiltered data used with respect to a heartbeat-detection system.

FIG. 3A is described with respect to at least the following elements:
300—pressure measurement graph; and
311—X axis (time), 312—Y axis (pressure), 313—unfiltered pressure values.

FIG. 3A shows a conceptual drawing of unfiltered pressure measurement data comparing an X axis 311 (describing a time value or a count of a number of pressure measurement data points) and a Y axis 312 (describing an unfiltered pressure value or a sensor value responsive to a pressure value). In the FIG. 3A, an unfiltered pressure value graph 313 describes an unfiltered pressure value as measured with a user substantially present on the cushion 110.

In one embodiment, a pressure value sensor can determine a set of unfiltered pressure values exerted by the cushion 110 in support of the user 140 in a 1st convenient measure, such as possibly pounds per square inch (psi). The control device 120 can convert the unfiltered pressure values from psi to a 2nd convenient measure, such as possibly kilopascals (KPa). While this Application primarily describes use of these selected unfiltered pressure values, there is no particular requirement for any such limitation, or even that both a 1st convenient measure and a different or separate 2nd convenient measure are used.

FIG. 3B shows a conceptual drawing of an example weighted average of pressure data used with respect to a heartbeat-detection system.

FIG. 3B is described with respect to at least the following elements:
300—pressure measurement graph; and
311—X axis (time), 312—Y axis (relative pressure), 323—simple difference of pressure values.

FIG. 3B shows a conceptual drawing of unfiltered pressure measurement data comparing an X axis 311 (describing a time value or a count of a number of pressure measurement data points) and a Y axis 312 (describing an unfiltered pressure value or a sensor value responsive to a pressure value). In the FIG. 3B, a weighted average pressure value graph 323 describes a weighted average of pressure values as measured with a user substantially present on the cushion 110.

In one embodiment, the control device 120 can receive the unfiltered pressure values exerted by the cushion 110 in support of the user 140 and can determine a weighted average of pressure data, such as using a simple moving average (SMA) or a simple difference of successive values. While this Application primarily describes use of a simple difference of successive values, there is no particular requirement for any such limitation. For example, a weighted moving average (WMA), an exponential moving average (XMA), or a combination or conjunction thereof can be used. For another example, another high-pass filter can be used to remove components of the input signal associated with slower changes that would otherwise have been removed by subtracting a moving average.

The inventors have found it useful to remove the slower changers, such as by subtracting a moving average, to allow the heartbeat detector to use the input signal's the noisiness, not its raw pressure values. This information can be combined with information about raw pressure to achieve greater confidence with respect to whether the user is present or absent. A change from low pressure to high pressure would ordinarily indicate that the user is present, but this is not certain. A change from low noisiness to high noisiness, and in particular, noisiness with a known pattern, such as a repeated heartbeat, would ordinarily indicate that the user is present. Using both can improve confidence with respect to whether the user is present, such as by avoiding cases in which the user is present but the pressure is still low, or in which the user is absent but the pressure is still high.

While this Application primarily describes a heartbeat detector which is responsive to a measure of noisiness of the input signal, there is no particular requirement for any such limitation. For example, the heartbeat detector can filter (or frequency transform) the input signal and review the filtered (or transformed) signal for selected frequencies, such as those associated with a heartbeat. For another example, the heartbeat detector can detect the user's heartbeat in response to an autocorrelation of the input signal. In alternative embodiments, the heartbeat detector can use one or more combinations or conjunctions of these techniques.

The control device 120 can standardize the simple difference of successive values so as to provide a sequence of values standardized to a zero-pressure value. Thus, the average of the SMA would be approximately zero. While this Application primarily describes standardizing the sequence of values to a zero-pressure value, there is no particular requirement for any such limitation; for example, the sequence of values can be standardized to any constant value or even not standardized at all.

FIG. 3C shows a conceptual drawing of a set of filtered pressure data, filtered to allow passage of only frequencies of about 60-80 beats/minute (bpm) and ready for input to a neural network.

FIG. 3C is described with respect to at least the following elements:
300—pressure measurement graph; and
311—X axis (time), 312—Y axis (relative pressure), 333—filtered pressure values.

FIG. 3C shows a conceptual drawing of filtered pressure data, filtered to allow passage of only frequencies of about 60-80 bpm and ready for input to a neural network. FIG. 3C shows an X axis 311 (e.g., a time value or a count of a number of pressure measurement data points) and a Y axis 312 (e.g., normalized and filtered pressure values or a sensor values). In the FIG. 3C, a normalized and filtered pressure value graph 333 describes a normalized and filtered pressure values as measured with a user substantially present on the cushion 110.

In one embodiment, the control device 120 can perform a bandpass filter operation on the moving average of the time-varying pressure. In one embodiment, the bandpass filter primarily allows passage of values within a normal human heartbeat range, such as within a range of about 60-80 beats/minute (bpm). However, there is no particular requirement for any such limitation; for example, the bandpass filter can allow passage of values substantially outside a normal human heartbeat range, such as might occur when the user is subject to bradycardia or tachycardia. Alternatively, the bandpass filter can primarily allow passage of values within a normal human breathing range, such as within a range of about 16-18 breaths/minute. However, there is no particular requirement for any such limitation; for example, the bandpass filter can allow passage of values substantially outside a normal human breathing range, such as might occur when the user is breathing relatively slowly or relatively rapidly.

As shown in the FIG. 3C, a result of the bandpass filter operation provides a waveform looking like a human heartbeat. While this Application there is no particular requirement for any such limitation; for example, the bandpass filter can allow passage of values which do not look like a human heartbeat, but which can be determined are indicative of a human heartbeat even when a human being would not so recognize the waveform. Alternatively, the bandpass filter can allow passage of values with a waveform looking like a human breathing sequence, or not looking like any human bodily function at all; for example, the waveform can be detectable as representative of the presence of a user by the neural network described with respect to the FIG. 4.

FIG. 4 shows a conceptual drawing of an example heartbeat-detection system with respect to a support cushion.

FIG. 4 is described with respect to at least the following elements:
400—heartbeat detection system;
402—microcontroller or microprocessor;
403—input port;
404—output port;
410—filter;
420—neural network; and
430—state machine.

In one embodiment, the heartbeat detection system 400 includes a filter 410 disposed to receive the filtered pressure values 333, as described with respect to FIG. 3C. As described herein, the filtered pressure values 333 can alternatively include a function of pressure values received from one or more sensors 115 coupled to associated air elements (cells) 112 of the cushion 110.

A sequence of outputs from the filter 410 can be coupled to the neural network 420. In one embodiment, the neural network 420 can be implemented using a microcontroller or microprocessor 402 (also referred to generally as a processor), such as one operating under software control and having neural network weighting values 426A, 426B, 426C, and 426D, such as used in the fields of convolutional neural network layers (CNN) or backpropagation neural network layers (BPL). In an example, the microcontroller or microprocessor can operate at a clock speed of about 32 MHz and can use about 350-400 neural network weights each including about two bytes of data, thus, less than about 2 kilobytes of data.

The inventors have found that operating the microcontroller or microprocessor at a relatively low clock speed and using a relatively small number of neural network weights can have the advantageous of using only a limited amount of power draw, thus, providing a heartbeat-detection system that can determine the presence/absence of a user 140 on the cushion 110 without draining a power source, such as a battery or capacitor, excessively quickly.

While this Application primarily describes the heartbeat detection system 400 with respect to a neural network that can determine the presence/absence of a user 140 on the cushion 110 without draining a power source excessively quickly, there is no particular requirement for any such limitation; for example, the cushion 110 can be coupled to an external battery (not shown), an external power source (not shown), a radio-frequency energy harvester (not shown), another source of power, or otherwise as described herein.

In one example, the heartbeat detection system 400 is described with respect to at least the following elements:
410—filter;
420—neural network; and
430—state machine.

In one embodiment, the microcontroller or microprocessor 402 can include a processor or another type of computing device, memory or another type of storage device, an input port 403 disposed to receive one or more of the filtered pressure values 333, and an output port 404 disposed to provide one or more indicators of the presence/absence of the user 140. In an example, the input port and output port may be a data input interface and a data output interface, which provide digital data interfaces. In an example, the input port and output port maybe a serial and/or parallel data interface of the microprocessor/microcontroller 402.

In an example, the filter 410 is described with respect to at least the following elements:
411—input port;
412—moving average sensor; and
413—frequency filter.

In one embodiment, the filter 410 can include an input port 411 disposed to receive an input signal, such as from a pressure sensor (e.g., the filtered pressure values 333 as described herein), a moving average sensor 412, such as a computing device disposed to determine a simple moving average of values from the pressure sensor (as described herein) or another type of moving average or low-pass filter disposed to filter away spikes or other noisy artifacts from the input signal, and a frequency filter 413 disposed to remove excess sensor noise other than those frequencies possibly associated with a human heartbeat, breathing rate, or other medical features associated with the presence of a user 140. While this Application is primarily described with respect to a heartbeat-detection system 400, there is no requirement for any such limitation; for example, the system 400 can alternatively be disposed to detect the user's breathing, another bodily function, or otherwise as described herein.

In one example, the neural network 420 is described with respect to at least the following elements:
421—1st convolutional layer;
422—2nd convolutional layer;
423—1st backprop layer;
424—2nd backprop layer; and
425—output nodes;
426A, 426B, 425C, 426D—neural network weights; and
427—output nodes.

In one embodiment, the neural network 420 can receive a set of about 60 successive pressure values from the filter 410, each of which can be distributed into a sequence of artificial neurons disposed in a first layer convolutional neural network 421. Each pair of neurons in the first convolutional layer 421 can be disposed to determine a difference value. The difference value can be coupled to a second convolutional layer 422, thus, providing about 30 output values from the first convolutional layer 421 to the second convolutional layer 422. Each neuron of the second convolutional layer 422 can be disposed to receive the (weighted) two values from the first convolutional layer 421 and to compute a modified ReLu value: maximum (difference, zero), thus, the difference of its two input values if that difference >zero, and zero otherwise.

The second convolutional layer 422 can thus provide a sequence of about 30 values from the output of the first convolutional layer 421, each of which can be distributed into a sequence of artificial neurons disposed in a first backpropagation layer 423, thus, providing about 15 output values from the second convolutional layer 422 to the first backpropagation BPL layer 423. The first backpropagation BPL layer 423 can be fully coupled from about 15 input values to about 4 output values at output nodes 427. Thus, each neuron of the first backpropagation BPL layer 423 can be disposed to receive the (weighted) values from all of the neurons of the second convolutional layer 422 and to compute a modified “ReLu” value: maximum (difference, zero), thus, the sum of (all of) its input values if that difference >zero, and zero otherwise.

The first backpropagation BPL layer 423 can thus provide a set of about 4 output values at output nodes 427 to the second backpropagation BPL layer 424. The second backpropagation BPL layer 424 can be fully coupled from about 4 input values to two output values at two output nodes 425A and 425B. Thus, each neuron of the second BPL layer 423 can be disposed to receive the (weighted) values from all of the neurons of the first BPL layer 423 and to compute a modified “ReLu” value: maximum (difference, zero), thus, the sum of (all of) its input values if that difference >zero, and zero otherwise.

The backpropagation layer 424 can be coupled to one or more output nodes. The two output nodes 425 can include (A) a first output node 425 disposed to indicate a confidence level that the user 140 is present, and (B) a second output node 425 disposed to indicate a confidence level that the user 140 is absent. Each confidence level can include a value between −1 and +1. The first output node 425 can have a value between −1 (in which the neural network 420 is confident the user 140 is absent) and +1 (in which the neural network 420 is confident the user 140 is present). The second output node 425 can have a value which is the reverse (thus, −1 indicating confidence that the user is present and +1 indicating confidence that the user is absent).

While this Application primarily describes the neural network 420 as having two convolutional layers 421 and 422 and two backpropagation layers 423 and 424, disposed as described, having selected numbers of nodes in each such layer 421, 422, 423, and 424, disposed as described, and having a selected activation function (ReLu) for each neural network node, there is no particular requirement for any such limitation. In alternative embodiments, the neural network 420 can have other numbers, order, or connectivity of convolutional layers or backpropagation layers, and/or other types of layers or connectivity for neural network nodes. Similarly, the neural network 420 can have other activation functions and need not have the same activation function for each neural network node.

While this Application primarily describes use of a neural network to determine the confidence that the user is present in response to a signal which might show the user's heartbeat, there is no particular requirement for any such limitation. In alternative embodiments, the heartbeat detector can use any technique which provides a measure of confidence that the input signal (e.g., the filtered pressure values 333) shows the user's heartbeat; thus, that the user is present. While a neural network is useful to determine confidence in response to relatively noisy data, the neural network could be replaced or supplemented with an alternative technique.

For example, the heartbeat detector 400 can use any technique to provide a scalar value to output to the state machine 430. In alternative embodiments, these techniques can include linear filters, nonlinear filters, impulse response filters (such as one or more FIR or IIR filters), or other techniques that receive the input signal and output a confidence value to output to the state machine 430. The techniques can include a bandpass filter to identify a frequency associated with a heartbeat and a technique to determine whether the signal strength at that frequency is sufficiently regular.

In one embodiment, the heartbeat detector 400 can be also used in combination with other techniques to determine whether the user 140 is present. In embodiments in which the other techniques are sufficiently robust, the heartbeat detector 400 can use one or more techniques for which the confidence level of the heartbeat detector 400 is not the strongest component of determining whether the user 140 is present.

In alternative embodiments, the heartbeat detector 400 can include a different type of classification technique, such as one capable of determining whether the signal “looks like” a heartbeat. The heartbeat detector 400 can include any classifier or can replace one or more of the neural network layers 421, 422, 423, or 424 with an alternative nonlinear classifier, such as: a machine learning classifier; a feedforward neural network trained as a classifier; an n-dimensional classifier with input dimensions responsive to the input signal; a support vector machine with input dimensions responsive to the input signal and scaled for effectiveness; a Kohonen network with an energy function selected for effectiveness; a transformer model or large language model trained on input tokens responsive to the input signal; and any other system having the effects described herein.

In general, the heartbeat detector 400 can include any system which can detect data using a nonlinear model, or which can detect data using a mostly-linear model when accuracy is not at a premium.

In one example, the state machine 430 is described with respect to at least the following elements:
431—difference sensor;
432—state elements;
433—state transitions; and
434—yes/no output node.

In one embodiment, the state machine 430 can include a difference sensor 431 coupled to the two output nodes 425 of the neural network 420, a set of state elements 432 each disposed to represent whether the state machine 430 is then-currently occupying that state, a set of state transitions 433 each disposed to indicate when the state machine 430 transfers from one state to another, and a single yes/no output node 434 disposed to indicate whether the state machine 430 asserts that the user 140 is present on (if “yes”) or absent from (if “no”) the cushion 110.

The difference sensor 431 can determine a difference in the confidence levels from the output nodes 425, thus, providing a difference between −2 (not confident in one direction and very confident in the other direction) and +2 (confidence in the reverse direction). When the difference sensor 431 indicates that the state machine 430 is confident in one direction by more positive than about +0.2, the state machine 430 performs a state transition 433 between a state element 432 in the direction of more confident (that the user is present) by one step, and when the state machine 430 is confident in one direction by more positive than about +1.5, the state machine 430 performs a state transition 433 in the direction of more confident that the user is present by two steps.

Similarly, when the state machine 430 is confident in one direction by more negative than about −0.2, the state machine 430 performs a state transition 433 in the direction of less confident (that the user is present) by one step and when the state machine 430 is confident in one direction by more negative than about −1.5, the state machine 430 performs a state transition 433 in the direction of less confident by two steps. When the state machine 430 is confident in one direction by about between −0.2 and +0.2, the state machine leaves the current state element 432 unchanged.

In one embodiment, the state machine 430 can include five states, respectively indicating that it believes the user 140 is definitely absent, possibly absent, uncertain, possibly present, or definitely present. When the state machine 430 determines that the user 140 is definitely or possibly absent, it disposes the yes/no output node 434 to output “no” the user 140 is absent; when the state machine 430 determines that the user 140 is definitely or possibly present, it disposes the yes/no output node 434 to output “yes” the user 140 is present. If the state machine 430 is at the “uncertain” state element 432, it disposes the yes/no output node 434 to output neither “yes” nor “no”.

While this Application describes the state machine 430 as using particular values of +/−0.2 and +/−1.5, and transitions of +/−1 step and 2 steps, there is no particular requirement for any such limitation. Other thresholds can be used, whether closer together or further apart; fewer or more steps can be used; or otherwise as described herein. Similarly, while this Application describes the state machine 430 as using particular numbers of states and particular thresholds for indicating whether the user 140 is present/absent, there is no particular requirement for any such limitation. Other thresholds can be used, whether closer together or further apart; fewer or more steps can be used; or otherwise as described herein.

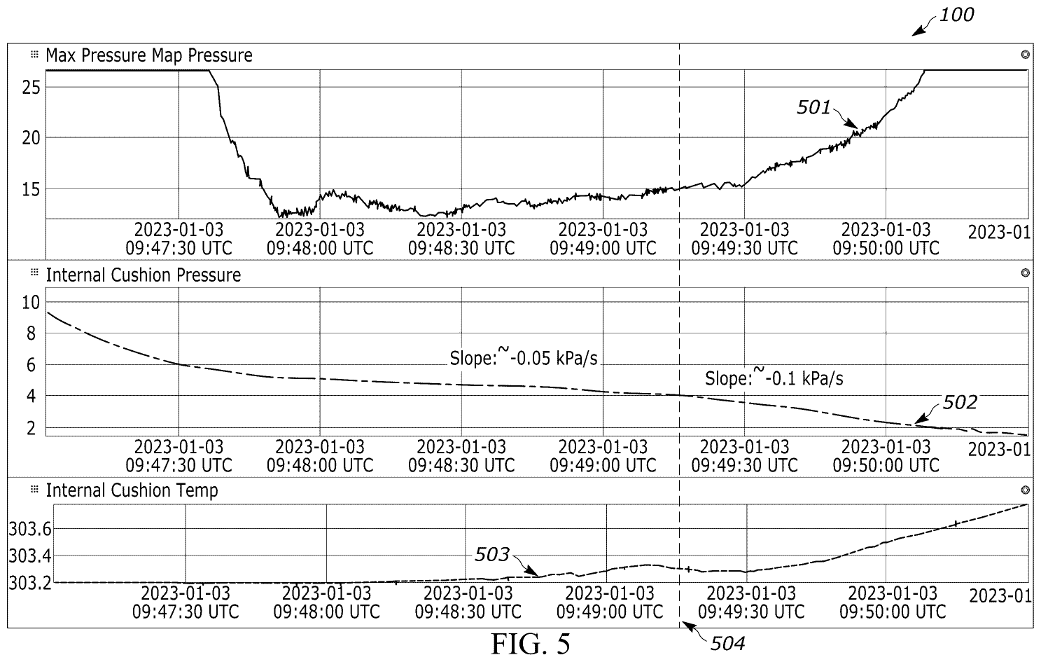

FIG. 5 shows a conceptual drawing of an example set of measurements of pressure to detect bottoming-out with respect to a support cushion.

FIG. 5 is described with respect to at least the following elements:
501—a signal indicating a pressure exerted to support the user 140;
502—a 1st derivative of that pressure, with a designated slope as marked;
503—an internal cushion temperature, with a likely bottoming-out showing a rapid increase in temperature; and
504—a likely bottoming-out as marked.

### Detecting User “Bottoming Out”

In one embodiment, the control device 120 can determine whether the user 140 has “bottomed out”. The control device 120 can receive pressure information from a selected one or more cells 112. The control device 120 can adjust the pressure of those selected one or more cells 112 and determine a localized derivative of pressure (as a function of time) with respect to time, thus, (d Pressure/dt). The control device 120 can determine that the user 140 has “bottomed out” when the determined derivative (d Pressure/dt) is substantially zero, thus, the pressure on the selected cell 112 does not change substantially when air mass is injected or removed from the selected cell 112.

In alternative embodiments, the control device 120 can determine whether the user 140 has “bottomed out” in response to detecting the user's breathing or heartbeat. The control device 120 can detect amplification of the user's breathing or heartbeat in response to the user's resting on the hard surface 111. For example, an amplification of the user's breathing or heartbeat may involve the user's breathing rate (e.g., in breaths per minute) and or heat rate (e.g., in beats per second) increasing in response to the user resting on the hard surface.

A bottoming-out detection system receives a first signal 501 indicating a pressure exerted to support the user 140. The bottoming-out detection system determines a 1st derivative 502 of that pressure, which has a designated slope as marked in the figure. The bottoming-out detection system determines whether the 1st derivative 502 of that pressure is more or less than a selected threshold, thus indicating a phase change between support of the user 140 or lack of support of the user 140. A likely bottoming-out 504 can be determined, as marked in the figure. The likely bottoming-out 504 can also be confirmed by comparison with an internal temperature 503 of the cushion 110.

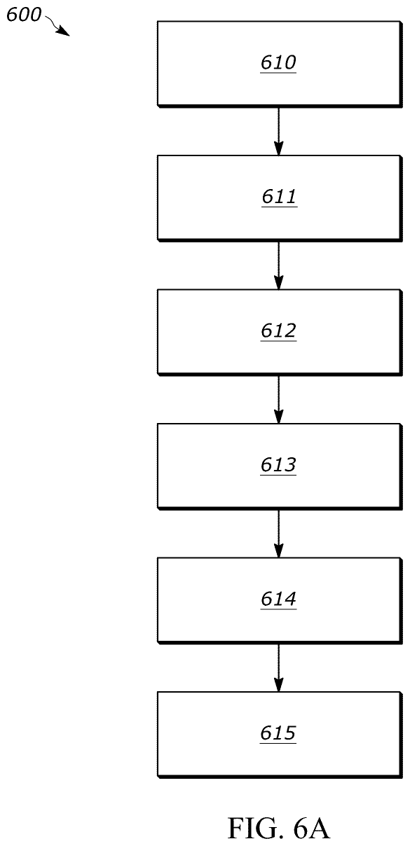

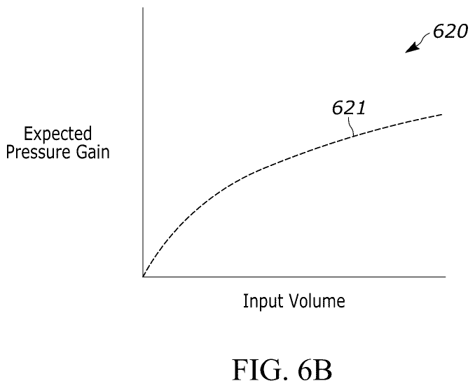

FIG. 6A shows a conceptual drawing of an example process associated with detecting a cushion leak.

### Detecting Cushion Leak

In one embodiment, the control device 120 can be disposed to determine whether the cushion 110 is leaking air. When the control device 120 detects reduced pressure, the control device 120 can re-inflate the cushion 110 to a safer or otherwise more acceptable amount of pressure. If this is inadequate to maintain pressure, the control device 120 can determine that the cushion 110 has a leak, and can alert the user 140, caregivers or medical personnel 150, or otherwise as described herein. For example, the control device 120 can send an alert to a smartphone or other mobile device 130 associated with the user 140, or to a display 132 associated with the wheelchair on which the user 140 and the cushion 110 are located, either of which can present a status report to the user 140 indicating that a leak was detected. The control device 120 can also log its determination of the leak and alert personnel to replace the cushion 110. In an example, the control device may include a cushion leak status indicator such as a light that is visible on an exterior of an enclosure of the control device. In response to detection of a leak, the control device may activate the cushion leak status indicator (e.g., turn on a light) to provide a visual indication that the cushion has a leak. In an example, a cushion leak status indicator may be in the form of an audio indicator in addition to, or instead of, the visual indicator.

In one embodiment, the control device 120 can perform a process 600 including one or more of the following steps. As described herein, the process 600 provides a relatively long-term accounting with respect to pumps and/or vents, such as associated with an amount of air being input to or output from one or more cells 112 associated with the cushion 110.

At a step 610, the control device 120 can initialize a ring buffer to zero values and set a pointer to indicate a most-recent measurement recorded in the ring buffer. For example, the ring buffer can maintain a most-recent set of entries. In one embodiment, the ring buffer can maintain ten entries, but this can be any reasonable number of entries. For example, the ring buffer can include 10-20 entries, approximately each 1-5 minutes apart, thus between 10-100 minutes of recorded entries, or any other reasonable timing and number of entries.

Thereafter, the control device 120 can perform the following leak detection steps periodically, such as each minute or each five minutes, or otherwise from time to time, such as randomly determined using a Poisson distribution with a parameter of about one to five minutes.

At a step 611, the control device 120 can receive a measurement of pumping and/or venting time (or vacuum pumping time) from one or more sensors 115 associated with one or more pumps 113 associated with one or more cells 112 associated with the cushion 110. In response thereto, the control device 120 can determine an amount of air input to the cell 112 and an amount of air output from the cell 112. If the input amount exceeds the output amount (“excess input air”) by too much over a relatively long duration the control device 120 can determine that the cushion 110 has a leak. The control device 120 can determine that the excess air is “too much” when it is more than a selected threshold. The “relatively long duration” can include a selected duration between several minutes and several hours.

At a step 612, the control device 120 can enter the measurement it received in the previous step into the ring buffer and update the ring buffer's pointer to move to a next record. In one embodiment, the control device 120 can record a nonzero measurement only when the measurement exceeds a minimum threshold, such as about 1-2 seconds of (pumping time-venting time).

Alternatively, the control device 120 can maintain a record of every pump/vent action in the ring buffer instead of just the total pumping/venting time. This can include more detailed information but can use more memory.

At a step 613, the control device 120 can maintain a running total of excess (pumping-venting) time in response to the individual measurements.

At a step 614, the control device 120 can determine whether the total recent excess air is too much by comparing a value for its running total for an oldest and a newest recorded time. For example, subtracting the running total of the (oldest-newest) recorded time can provide a total excess air for the total time recorded in the ring buffer.

When the total recent excess air exceeds about 30-60 seconds of excess (pumping time—venting time), the control device 120 can determine that too much excess air has been input to the cushion 110 over the recent time (the time recorded in the ring buffer). Alternatively, when the total recent excess air exceeds about 1-2% of the air mass of the cushion 110, the control device 120 can determine that too much excess air has been input to the cushion 110 over the recent time. In one embodiment, the total air mass in the cushion 110 is about 8-13 grams of air.

FIG. 6B is an example of a graph 620 of threshold expected pressure gains versus volume of air that is input to a cell (bladder) of a cushion, identified as pressure vs. volume curve 621. In an example, a leak is determined to be present when a measured pressure gain is below an expected pressure gain for a known input volume of air. Thus, the area under the pressure vs. volume curve 621 corresponds to a leak condition of a cushion. Such a pressure vs. volume curve can be generated from bench tests of quantified air volume inputs tracked against measured pressure gains. In an example, the control device is configured to track input volumes and pressure gains and to automatically detect a leak when a measured pressure gain is below the pressure vs. volume curve for a known input volume. In an example, detection of a leak can be indicated by activating a leak detected indicator light on the control device.

When too much excess air has been input to the cushion 110 over the recent time (e.g., when a measured pressure gain is below the pressure vs. volume curve 621 for a known input volume, see FIG. 6B), the control device 120 can determine that the cushion 110 has a leak. The control device 120 can determine a seriousness of the leak in response to how much excess air has been input to the cushion 110 over the recent time.

Alternatively, the control device 120 can maintain a counter which records how often the pump 113 is active/pumping over the recent time. When the counter exceeds a selected threshold, the control device 120 can determine that the cushion 110 has a leak. For example, the ring buffer can maintain a record of whether or not the pump 113 is active/pumping for each 30 second timeslot over a sequence of 120 such timeslots (thus, one hour). When the pump 113 is active/pumping for more than 5-10% of those timeslots, the control device 120 can determine that the cushion 110 has a leak.

At a step 615, when the control device 120 determines that the cushion 110 has a leak, the control device 120 can push an alert to the remote device 130 or to a display 132. The control device 120 can take other actions instead or in addition, such as (A) sending an alert to caregivers or medical personnel 150; (B) logging its determination of the leak and alerting personnel to replace the cushion 110; (C) altering its control of pumping/venting in response to the leak; or otherwise as described herein.

The process can be repeated, including the steps 611-614, so long as the cushion is in use.

In one embodiment, the control device 120 can adjust the pumping/venting time (either before recording that time or when determining a total time) in response to a rotation speed of one or more pumps 113. The control device 120 can determine the rotation speed of the pump 113 in response to a pressure sensor 115, polled at a relatively high polling rate for a relatively short duration, and in response to pressure changes responsive to the pump's activity. The control device 120 can determine the rotation speed of the pump in response to the frequency of these pressure changes.

For example, the polling rate can include a rate of about once per 50 milliseconds, the duration can include a duration of about 0.5 seconds, and the detected pressure changes can include a pressure difference of about 1.5 psi or about 10 KPa, although any reasonable polling rate, duration, or detected pressure change would be workable, and is within the scope and spirit of the invention.

In one embodiment, the control device 120 can alter the amount of air input/output (either before recording the pumping/venting time or when determining a total time) in response to an adjustment of the amount of air that is input/output. The control device 120 can adjust the amount of air that is input/output in response to one or more factors relating to air density. These factors can include one or more of: ambient pressure or temperature, downstream pressure or temperature, pump rotation speed. battery voltage, and otherwise as described herein. The control device 120 can determine an estimated quantity of air actually moved, such as using information and models relating to gas kinematics.

### Long-Term Pressure Control

In one embodiment, the control device 120 can be disposed to determine whether the cushion 110 is within a selected preferred pressure range. When the control device 120 determines that the cushion 110 is not within the selected preferred pressure range (thus above/below that range), the control device 120 can direct the pumps 113 or vents 114 to adjust the internal pressure of the cushion 110, as described herein.

In one embodiment, the control device 120 can maintain a value including a cumulative pressure deviation from the selected preferred pressure range. For example, the preferred range can be between 0.35-0.45 psi. In one embodiment, the control device 120 can set the cumulative pressure deviation to zero whenever the cushion 110 is deactivated/reactivated, whenever the user 140 enters/exits the cushion 110, whenever the control device 120 completes adjusting the cushion's internal pressure, whenever an operator signals a “reset”, whenever the cushion's internal pressure is clearly within the preferred range, or otherwise as described herein.

In one embodiment, the control device 120 can receive information with respect to the internal pressure of the cushion 110. When the internal pressure is outside the preferred range by more than a selected threshold, the control device 120 can add to the cumulative pressure deviation by the amount outside the preferred range. For example, in one embodiment, the selected threshold can be about 0.05 psi, although any reasonable threshold (including a zero threshold) would be workable, and is within the scope and spirit of the invention.

When the adjustment reverses from positive/negative, or the reverse, the control device 120 can determine that the cushion 110 was within the preferred range for at least some time. In such cases, the control device 120 can reset the cumulative pressure deviation to zero.

When the adjustment continues to be in only one direction, thus, continues to be above the preferred range or continues to be below the preferred range, the control device 120 can add the adjustment to the cumulative pressure deviation. Thus, when a relatively long duration occurs when the pressure persists above the preferred range or persists below the preferred range, the (absolute value of the) cumulative pressure deviation will eventually exceed a selected threshold. For example, the selected threshold for the cumulative deviation can be about 20 total KPa-seconds (or about 3.0 total psi-seconds), although any reasonable threshold (including a zero threshold) would be workable, and is within the scope and spirit of the invention.

When the (absolute value of the) cumulative pressure deviation exceeds the selected threshold, the control device 120 can direct the pumps 113 or vents 114, as appropriate, to adjust the internal pressure of the cushion 110 until that internal pressure is within the preferred range. Once the internal pressure of the cushion 110 has been adjusted to within the preferred range, the control device 120 can reset the cumulative pressure deviation to zero. Thereafter, the control device 120 can continue to maintain a running total of the cumulative pressure deviation.

In one embodiment, the control device 120 can temporarily modify the selected thresholds for adding to the cumulative pressure deviation (normally about 0.05 psi) or for determining that the cumulative pressure deviation is too large (normally about 3.0 total psi-seconds), in response to information from the user 140. For example, when the user 140 changes the pressure setpoints to their selected preferred values, the control device 120 can reduce the selected thresholds to about 25-50% of their normal values. This can have the effect of providing a faster or more noticeable response to the user's action.

In one embodiment, the control device 120 can temporarily modify the selected thresholds in response to a measure of remaining battery charge. For example, when the battery indicates a “low battery” condition, such as being at 20% charge or less, the control device 120 can increase the selected thresholds to about 2-4 times their normal values. Alternatively, the selected thresholds can be inversely proportional to remaining battery charge. This can have the effect of conserving battery life, avoiding the cushion 110 running out of power, and allowing longer use even when battery is low.

In an example, a control device is connected to a cushion by an air hose. In an example, the cushion includes a single inlet for receiving air and the control device is configured to sense pressure in a bladder of the cushion, provide air to the bladder, and/or vent air from the bladder. In an example, a control device includes an inlet/outlet port, a pump, a vent, a pressure sensor, a processor, and memory, which are incorporated into an enclosure, such as an injected molded enclosure. In an example, the control device is able to be held in one hand of an adult human and can be manipulated by, for example, a user 140 of the cushion and/or a caregiver 150. FIG. 7 is a block diagram of an example of a control device 720 that may be used as control device 120. Elements included in the block diagram are an inlet and outlet port 770, a pump 772, a vent 774, a pressure transducer 776, a battery 778, a microprocessor 780, and a user interface 782 (e.g., power button, pressure control button, cushion leak status indicator, battery indicator, device status indicator, and/or speaker). In an example, the inlet and outlet port, the pump, the vent, and the pressure transducer are pneumatically coupled to each other, the battery provides power to the powered components (e.g., the pump, vent, pressure transducer, microprocessor, and user interface), the microprocessor implements control operations as disclosed herein, and the user interface provides a user interface to a person sitting on the cushion and/or to a caregiver. In an example, the control device 720 may be configured to implement the techniques related to measuring and adjusting pressure in a cushion as described herein. For example, the microprocessor may execute computer readable instructions to implement the techniques described herein including, for example, the techniques related to user presence detection, heartbeat and breathing detection, enter/exit detection, bottom out detection, leak detection, long term pressure control, and battery conservation.

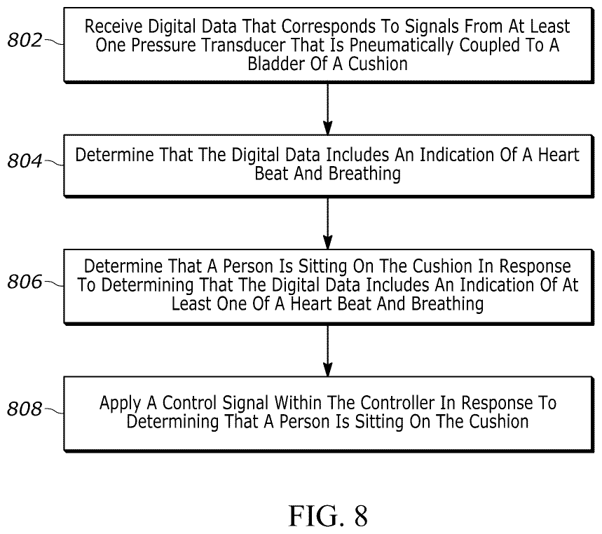

FIG. 8 is a process flow diagram of a method for operating a control device for a cushion. At block 802, digital data that corresponds to signals from at least one pressure transducer that is pneumatically coupled to a bladder of a cushion is received. At block 804, it is determined that the digital data includes an indication of at least one of a heart beat and breathing. At block 806, it is determined that a person is sitting on the cushion in response to determining that the digital data includes an indication of at least one of a heart beat and breathing. At block 808, a control signal is applied within the controller in response to determining that a person is sitting on the cushion.

In an example of such a control device, the control device may include at least the following: an injection-molded enclosure, an outlet port (which is couplable to a standard cushion interface, or to an intermediate device couplable to a standard cushion interface), a device status indicator (which is couplable to a display or to an auxiliary device which can present information on a display), a battery indicator, a cushion leak status indicator (which is couplable to a display or to an auxiliary device which can present information on a display), a “pressure preset/mode selector/pressure down” input (which is couplable to an input device, or which is couplable to an auxiliary device which can present inputs from another input device such as a smartphone or other mobile device), a “power button/pressure up” input (which is similarly couplable as the just-previous input element), a charging port, which is couplable to a power source.

In an example of such a control device, the control device may include at least the following: a device upper enclosure, a set of device button caps, a set of indicator light pipes (which are couplable to a set of indicator lights), one or more pump vibration isolators, one or more batteries, one or more pumps, one or more device circuit boards (such as maintaining hardware usable by the control device), one or more pressure sensors, one or more pneumatic gaskets, one or more solenoids or other vent controls, one or more speakers or other audio outputs, a device lower enclosure (such as including an integrated pneumatic manifold, such as couplable to a set of pump or vent controls), one or more device outlet ports (which are couplable to a set of pump or vent controls), one or more pneumatic manifold gaskets (such as couplable to a set of pump or vent controls), one or more gasket caps.

While this Application primarily describes systems and techniques that relate to a cushion operating with a control device, particularly with respect to an inflatable/deflatable cushion disposed to support a user, there is no particular requirement for any such limitation. For example, techniques described herein can be disposed to assist with or control operation of a cushion in a vehicle or other moving structure, or in response to operation of a cushion in response to control of an external device by an operator, or otherwise as described herein.

After reading this Application, those skilled in the art will recognize that the techniques described herein are applicable to a wide variety of types of devices, methods, and/or systems. Moreover, those skilled in the art will recognize that the techniques described herein are applicable to a wide variety of control techniques, including those which are controlled by a human operator, those which are controlled remotely, those which are controlled in co-operation by an operator and an instructor or other external controller, or otherwise controlled by a control device or control program (whether disposed locally or remotely, or some combination thereof), or otherwise as described herein.

This Application describes some examples with process steps, data structures, and, where applicable, control structures or control systems. After reading this Application, those skilled in the art would recognize that, where any calculation or computation is appropriate, embodiments of the description can be implemented using general purpose computing devices or switching processors, special purpose computing devices or switching processors, other circuits adapted to particular process steps and data structures described herein, or combinations or conjunctions thereof, and that implementation of the process steps and data structures described herein would not require undue experimentation or further invention.

A control element is disclosed. In an example, the control element being disposed to manage pressure in one or more cells of an inflatable cushioning surface, the control element being couplable to the one or more cells, the one or more cells being couplable to one or more pressure sensors or air volume sensors; the control element being couplable to one or more pumps or vents, the one or more cells being disposed to increase pressure in response to the pumps or to decrease pressure in response to the pumps or vents; the control element including: a processor and memory disposed to receive information from at least some of the pressure sensors or air volume sensors, disposed to determine an internal pressure of at least some of the cells, and disposed to issue one or more control signals directing at least some of the pumps or vents to adjust internal pressure of at least some of the cells; wherein the control element is disposed, when the user is present, to maintain the pressure or air volume of at least some of the cells within a selected pressure range using at least some of the pumps or vents to adjust internal pressure of at least some of the cells.

In an example of the control element, the processor and memory include a detector of a user heartbeat, breathing, or other bodily function; the detector including one or more of: a filter, a neural network, a state machine, or a combination thereof; the detector being responsive to one or more of: changes in pressure or user movements, to determine whether the user is present or absent, whether the user is entering or exiting the cushioning surface, or whether the user is uncomfortable.

In an example of the control element, the control element is decouplable from the cushioning surface.

In an example of the control element, the memory is disposed to maintain more than one user profile, each profile including its own selected pressure range, each profile being selectable in response to one of a plurality of selected distinct cushioning surfaces.

In an example of the control element, the control element is responsive to a user input to modify the selected pressure range.

In an example of the control element, the memory is disposed to maintain more than one user profile, each profile including its own selected pressure range, each profile being selectable in response to input from one or more of: a user, caregiver, medical personnel, or another person.

In an example of the control element, the control element is responsive to changes in pressure of at least some of the cells to determine a pressure of an ambient environment; and the control element is disposed, when the pressure of the ambient environment changes, to direct at least some of the pumps or vents to maintain the cushioning surface within the selected pressure range.

In an example of the control element, the control element is responsive to changes in pressure of at least some of the cells to determine whether any of the cells is leaking.

In an example of the control element, the control element is responsive to changes in pressure of at least some of the cells to determine whether any of the cells is leaking and a seriousness thereof; the control element is disposed, when any of the cells is leaking, to direct a display to present an alert to one or more of: the user, a caregiver, medical personnel, or another device.

In an example of the control element, the control element is responsive to changes in pressure of at least some of the cells to direct a display to present an alert to one or more of: the user, a caregiver, medical personnel, or another device.

In an example of the control element, the control element is responsive to changes in pressure of at least some of the cells to determine whether the user is entering or exiting the cushioning surface; and the control element is disposed, when the user is entering or exiting the cushioning surface, to direct at least some of the pumps or vents to assist the user with entering or exiting the cushioning surface.

In an example of the control element, the control element is couplable to a plurality of cushioning surfaces, and is disposed to maintain the pressure or air volume of each of the plurality of cushioning surfaces within its own selected pressure range.

In an example of the control element, the control element is disposed, when the user is not present, to measure an air volume associated with the cushioning surface to determine one or more parameters associated with maintaining the cushioning surface within the selected pressure range.

In an example of the control element, the cushioning surface is associated with a plurality of cells each having its own measurable pressure; the control element is disposed to separately determine the pressure associated with one or more of the cells; and the control element is disposed, when the user is present, to determine a pressure associated with one or more of the user's anatomical regions.

In an example of the control element, those anatomical regions include one or more of: an ischial tuberosity, a thigh, another anatomical region.

In an example of the control element, the control element is disposed, when the user is present, to maintain the pressure or air volume of a first one of the cells different from the pressure or air volume of a second one of the cells.

In an example of the control element, the control element is disposed to maintain the pressure or air volume of the first one of the cells different from the pressure or air volume of the second one of the cells so as to assist the user with maintaining a selected posture.

In an example of the control element, the control element is disposed to maintain the pressure or air volume of the first one of the cells different from the pressure or air volume of the second one of the cells so as to assist the user with managing a pelvic obliquity.

In an example of the control element, the control element is disposed to determine whether the user has bottomed-out with respect to the cushioning surface.

In an example of the control element, the determination of whether the user has bottomed-out with respect to the cushioning surface is responsive to one or more of: a step change in a derivative, a multiple derivative, or a statistical measure, of a signal with respect to pressure, air mass, or volume, relating to at least some of the cells.

In an example of the control element, the determination of whether the user has bottomed-out with respect to the cushioning surface is responsive to a determination of whether the user's weight is at least partially resting on a support below the cushioning surface.

In an example, the control element includes a temperature sensor couplable to one or more of the cells associated with the cushioning surface; wherein the control element is disposed to adjust an air flow associated with the cushioning surface, to reduce a temperature of at least part of the cushioning surface associated with the user's seating area.

In an example, the control element includes a temperature sensor couplable to one or more of the cells associated with the cushioning surface; wherein the control element is disposed to determine the user's weight in response to one or more of: pressure or air volume changes associated with the cushioning surface when the user rests on the at least part of the cushioning surface.

In an example of the control element, the control element is disposed to determine one or more of: user activity, fidgeting, pressure offloads, or another movement with respect to the cushioning surface.

In an example of the control element, the determination of a seriousness of leaking is responsive to one or more of: an air flow rate, a comparison of the air flow rate with a pumping rate.

In an example of the control element, the control element is disposed to send information with respect to a status of at least some of the cells associated with the cushioning surface to the user, caregiver, medical personnel, or another device; wherein that information includes one or more of: audio, video, another signal.

In an example of the control element, the control element is disposed, when the user is present, to determine one or more of: whether installation thereof is correct, whether the control element has been pneumatically disconnected.

In an example of the control element, the control element is disposed to determine whether a user is present on the cushioning surface, in response to the information from at least some of the pressure sensors or air volume sensors, and in response to one or more of: a user heartbeat, breathing, or another bodily function.

Measuring and adjusting pressure of support cushions is disclosed herein. The measuring and adjusting pressure of support cushions including detecting user presence/activity and measuring/adjusting pressure of selected ones of multiple cells of a pressurized cushion using a control device, and user input/output using a smartphone or other device. The control device is disposed to detect/control the pressure in each cell, determine user presence (based on breathing or heartbeat) and conditions (based on changes in cell pressure), support user positioning on the cushion, assist user comfort/movement (based on movement/fidgeting) entering/exiting the cushion, protect against user falls or “bottoming out”, adjust for changes in ambient air pressure, and exchange information with the user, a caregiver, or medical personnel.

The preceding detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The connections as discussed herein may be any type of connection suitable to transfer signals or power from or to the respective nodes, units, or devices, including via intermediate devices. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. The term “coupled” or similar language may include a direct physical connection or a connection through other intermediate components even when those intermediate components change the form of coupling from source to destination.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method comprising:
receiving digital data that corresponds to signals from at least one pressure transducer that is pneumatically coupled to a bladder of a cushion;
determining that the digital data includes an indication of at least one of a heart beat and breathing;
determining that a person is sitting on the cushion in response to determining that the digital data includes an indication of at least one of a heart beat and breathing; and
applying a control signal within the controller in response to determining that a person is sitting on the cushion.

2. The method of claim 1, wherein determining that the digital data includes an indication of at least one of a heart beat and breathing involves filtering the digital data to pass digital data at a frequency of a heartbeat of a human.

3. The method of claim 2, wherein the frequency of a heartbeat of a human is in the range of about 60-80 beats per minute.

4. The method of claim 1, wherein determining that the digital data includes an indication of at least one of a heart beat and breathing involves filtering the digital data to pass digital data at a frequency of breathing of a human.

5. The method of claim 2, wherein the frequency of breathing of a human is in the range of about 10-20 breaths per minute.

6. The method of claim 1, wherein determining that the digital data includes an indication of at least one of a heart beat and breathing involves performing a frequency transform of the digital data, and determining that the digital data includes an indication of at least one of a heart beat and breathing from the frequency transform.

7. The method of claim 1, wherein determining that the digital data includes an indication of at least one of a heart beat and breathing involves performing a frequency transform of the digital data, and determining that the digital data includes an indication of at least one of a heart beat and breathing from noise in the frequency transform.

8. The method of claim 1, wherein determining that the digital data includes an indication of at least one of a heart beat and breathing involves determining moving averages of the digital data.

9. The method of claim 1, wherein determining that the digital data includes an indication of at least one of a heart beat and breathing involves determining moving averages of the digital data, and applying the moving averages to a neural network that is configured to output a confidence value with respect to whether a heartbeat or breathing is present in the digital data.

10. The method of claim 1, wherein determining that the digital data includes an indication of at least one of a heart beat and breathing involves determining moving averages of the digital data, and filtering the moving averages to remove frequencies that are too high to be associated with a human heartbeat.

11. The method of claim 1, wherein determining that the digital data includes an indication of at least one of a heart beat and breathing involves determining moving averages of the digital data, and filtering the moving averages to remove frequencies that are above about 80 beats per minute.

12. A controller for a cushion, the controller comprising:
a processor configured to;
receive digital data that corresponds to signals from a pressure transducer that is pneumatically coupled to a bladder of a cushion;
determine that the digital data includes an indication of at least one of a heart beat and breathing;
determine that a person is sitting on the cushion in response to determining that the digital data includes an indication of at least one of a heart beat and breathing; and
apply a control signal within the controller in response to determining that a person is sitting on the cushion.

13. The controller of claim 12, wherein determining that the digital data includes an indication of at least one of a heart beat and breathing involves filtering the digital data to pass digital data at a frequency of a heartbeat of a human.

14. The controller of claim 13, wherein the frequency of a heartbeat of a human is in the range of about 60-80 beats per minute.

15. The controller of claim 12, wherein determining that the digital data includes an indication of at least one of a heart beat and breathing involves filtering the digital data to pass digital data at a frequency of breathing of a human.

16. The controller of claim 15, wherein the frequency of breathing of a human is in the range of about 10-20 breaths per minute.

17. The controller of claim 12, wherein determining that the digital data includes an indication of at least one of a heart beat and breathing involves performing a frequency transform of the digital data, and determining that the digital data includes an indication of at least one of a heart beat and breathing from the frequency transform.

18. The controller of claim 12, wherein determining that the digital data includes an indication of at least one of a heart beat and breathing involves performing a frequency transform of the digital data, and determining that the digital data includes an indication of at least one of a heart beat and breathing from noise in the frequency transform.

19. The controller of claim 12, wherein determining that the digital data includes an indication of at least one of a heart beat and breathing involves determining moving averages of the digital data.

20. The controller of claim 12, wherein determining that the digital data includes an indication of at least one of a heart beat and breathing involves determining moving averages of the digital data, and applying the moving averages to a neural network that is configured to output a confidence value with respect to whether a heartbeat or breathing is present in the digital data.

21. The controller of claim 12, wherein determining that the digital data includes an indication of at least one of a heart beat and breathing involves determining moving averages of the digital data, and filtering the moving averages to remove frequencies that are too high to be associated with a human heartbeat.

22. The controller of claim 12, wherein determining that the digital data includes an indication of at least one of a heart beat and breathing involves determining moving averages of the digital data, and filtering the moving averages to remove frequencies that are above about 80 beats per minute.

23. The controller claim 12, further including:
a port configured to hold a hose that channels air between the controller and the bladder of the cushion;
a pump pneumatically connected to the port; and
the pressure transducer pneumatically connected to the port.

24. The controller of claim 23, wherein the controller is external to the cushion.

25. A controller for a cushion, the controller comprising:
an inlet and outlet port;
a pump pneumatically coupled to the inlet and outlet port;
a vent pneumatically coupled to the inlet and outlet port;
a pressure transducer pneumatically coupled to the inlet and outlet port;
a battery;
a user interface; and
a processor configured to;
receive digital data that corresponds to signals from the pressure transducer when the pressure transducer is pneumatically coupled, via the inlet and outlet port, to a bladder of a cushion;
determine that the digital data includes an indication of at least one of a heart beat and breathing; and
determine that a person is sitting on the cushion in response to determining that the digital data includes an indication of at least one of a heart beat and breathing.
